(19) United States
(12) Patent Application Publication
(10) Pub. No.: US 2022/0191578 A1
(43) Pub. Date: Jun. 16, 2022

(54) MISCELLANEOUS COATING, BATTERY, AND CLOCK FEATURES FOR ARTIFICIAL REALITY APPLICATIONS

(71) Applicant: Facebook Technologies, LLC, Menlo Park, CA (US)

(72) Inventors: Vasanth Kumar Ramkumar, Fremont, CA (US); Raghav Rao, Fremont, CA (US); Alex Ockfen, Bothell, WA (US); Rajesh Prasannavenkatesan, Menlo Park, CA (US); David Brokenshire, Maidenhead (GB); Eric Mun Khai Leong, Kirkland, WA (US); Jacklyn Ann Holmes Herbst, Bellevue, WA (US); Matthew Aaron, San Francisco, CA (US); Jason Michael Battle, Bothell, WA (US); Dong Rim Lee, San Jose, CA (US); Arman Boromand, Issaquah, WA (US)

(21) Appl. No.: 17/678,972

(22) Filed: Feb. 23, 2022

Related U.S. Application Data
(60) Provisional application No. 63/180,542, filed on Apr. 27, 2021.
(60) Provisional application No. 63/187,235, filed on May 11, 2021.
(60) Provisional application No. 63/233,413, filed on Aug. 16, 2021.
(60) Provisional application No. 63/234,628, filed on Aug. 18, 2021.
(60) Provisional application No. 63/298,294, filed on Jan. 11, 2022.

(51) Int. Cl. H04N 21/43; H04N 21/4363; C09D 5/22; H01M 50/124; H01M 50/188; H01M 50/148; G06F 1/28

(52) U.S. Cl. CPC H04N 21/4302; H04N 21/43635; C09D 5/22; H04L 67/12; H01M 50/188; H01M 50/148; G06F 1/28; H01M 50/124

(57) ABSTRACT

Some embodiments relate to a method for performing a battery power-based control of an in-call experience based on shared battery power information. Some embodiments relate to a coating of a headset that has a first emissivity over an ultraviolet band and a near-infrared band, a second emissivity over a visible band, and a third emissivity over a mid-to-far infrared band. Some embodiments relate to an aggregate coating of a headset. A thin films is applied to a surface of the headset, and a paint coating is applied to a surface of the thin film to form the aggregate coating. Some embodiments relate to a method for a high-definition multimedia interface derived network timing for distributed audio-video synchronization. Some embodiments relate to a battery containment structure with a metal chassis having surfaces coated with electrical insulators configured to receive a battery, and a lid coupled to the metal chassis.

### CROSS REFERENCE TO RELATED APPLICATIONS

This application claims a priority and benefit to U.S. Provisional Patent Application Ser. No. 63/180,542, filed Apr. 27, 2021, U.S. Provisional Patent Application Ser. No. 63/187,235, filed May 11, 2021, U.S. Provisional Patent Application Ser. No. 63/233,413, filed Aug. 16, 2021, U.S. Provisional Patent Application Ser. No. 63/234,628, filed Aug. 18, 2021, and U.S. Provisional Patent Application Ser. No. 63/298,294, filed Jan. 11, 2022, each of which is hereby incorporated by reference in its entirety.

### FIELD OF THE INVENTION

The present disclosure relates generally to artificial reality systems, and specifically relates to miscellaneous coating, battery, and clock features for artificial reality applications.

### BACKGROUND

With growing popularity of communication systems (e.g., smart phones, smart home systems), a smooth immersive in-call experience is desired when two or more users are communicating with each other using the communication systems over a network.

Many communication systems use existing networks to allow users to experience a variety of user applications, such as music and video sharing, gaming, etc. These user applications are designed to provide the users with an immersive in-call experience using a variety of technologies including augmented reality/virtual reality effects, high video and image resolution, etc. When the systems are powered by unlimited available energy, such as when plugged into an electrical outlet, the performance of the systems and the immersive in-call experiences of the users are not affected by the amount of energy that is available to each of the individual systems. In contrast, when the systems are each powered using a limited energy resource, such as battery-based energy, a power level in the battery of any system impacts performance of that system, and consequently, impacts the immersive in-call experience of the users of the other participating systems during the call. Thus, as the power level in the battery declines in a system, the in-call user experience of all the users in the call may deteriorate due to issues such as call drops, frame freezes, etc.

Commercial off-the-shelf (OTS) paints and coatings are traditionally designed with a single objective, such as achieving a (i) desired color, or (ii) to protect a surface from hostile environments. Moreover, such OTS products do not account for both minimizing heating of a device (e.g., headset) from the sun and radiative cooling of heat produced by the device.

When considering audio capture during a typical video conference, a distance between an active speaker and a capture device (microphone) directly affects the audio quality. This is due to the relationship between the room reverberation environment and the direct sound path (distance between the microphone and the active speaker), combined with the signal-to-noise/sensitivity characteristics of the audio capture device.

In a large video conferencing environment with multiple active speakers, several microphones are typically required to minimize the direct sound path distance for all participants. This may be achieved with direct wiring from a microphone to the main processing device but requires dedicated wiring for each microphone. Increasing the number of microphones increases the installation effort, cost, and complexity. This complexity becomes increasingly significant when incorporating multiple sensors for applications such as microphone-array beamforming.

Designing a battery containment structure (i.e., nest) to contain a lithium battery in consumer electronic devices is challenging. This is especially the case for smaller portable devices, such as eyewear devices (i.e., headsets).

### SUMMARY

Embodiments of the present disclosure relate to a method for performing a battery power-based control of an in-call experience based on shared battery power information at a client device. The method comprises: receiving, at a first communication system, information about a battery power of a second communication system that is in communication with the first communication system; determining that the received information indicates that the battery power is less than a prespecified threshold; and configuring one or more applications at the first communication system that are in use during the communication with the second communication system based on the received information about the battery power of the second communication system.

Embodiments of the present disclosure further relate to a coating of a consumer electronic device (e.g., headset). The consumer electronic device in an active state is configured to generate heat. The coating is configured to: have an emissivity of a first average value over an ultraviolet (UV) band of radiation and a near-infrared (NIR) band of radiation; have an emissivity of a second average value over a visible band of radiation; and have an emissivity of a third average value over a mid-to-far infrared band of radiation. One or more thin films can be applied to a first surface of the consumer electronic device, and a paint coating can be applied to a surface of the one or more thin films to form the coating as an aggregate coating. The aggregate coating has an emissivity distribution that includes an UV band, a NIR band, a visible band, and a mid-to-far infrared band. A first portion of the emissivity distribution in the UV and NIR bands can be lower than a second portion of the emissivity distribution in the visible band. The second portion of the emissivity distribution in the visible band can be lower than a third portion of the emissivity distribution in the mid-to-far infrared band. The aggregate coating presents as a target color, and heat generated by the consumer electronic device in the mid-to-far infrared band can be substantially absorbed and re-radiated.

Embodiments of the present disclosure further relate to a method for a derived network timing for distributed audio-video synchronization. The method comprises: extracting a clock signal using a high-definition multimedia interface connection between a first device and a second device; generating a precision time protocol (PTP) hardware clock using the extracted clock signal; and synchronizing a clock on an apparatus that is separate from the first device and the second device using the PTP hardware clock.

Embodiments of the present disclosure further relate to a battery containment structure, e.g., for integration into headsets. The battery containment structure comprises a metal chassis configured to receive a battery. The metal chassis includes five surfaces that are each coated with an electrical insulator. The battery containment structure further comprises a lid configured to couple to the metal chassis. The lid is configured to be coupled to the battery to form a battery assembly that when coupled to the metal chassis forms the battery containment structure.

### BRIEF DESCRIPTION OF THE DRAWINGS

FIG. 1A is a perspective view of a headset implemented as an eyewear device, in accordance with one or more embodiments.

FIG. 1B is a perspective view of a headset implemented as a head-mounted display, in accordance with one or more embodiments.

FIG. 2 is a block diagram of an audio system, in accordance with one or more embodiments.

FIG. 3 is a block diagram of a system environment for a communication system, in accordance with one or more embodiments.

FIG. 4 is a block diagram of a battery power-based control module, in accordance with one or more embodiments.

FIG. 5A illustrates an example side view of a battery containment structure, in accordance with one or more embodiments.

FIG. 5B illustrates an example top view of a battery containment structure, in accordance with one or more embodiments.

FIG. 5C illustrates an example battery pack with a lid for placement into a battery containment structure, in accordance with one or more embodiments.

FIG. 5D illustrates a more detailed view of the battery pack with the lid, in accordance with one or more embodiments.

FIG. 5E illustrates a detailed top view of a sheet metal of a battery containment structure, in accordance with one or more embodiments.

FIG. 6A illustrates an example spectral emissivity for black coating of a device, in accordance with one or more embodiments.

FIG. 6B illustrates an example spectral emissivity for green coating of a device, in accordance with one or more embodiments.

FIG. 7 illustrates an example allowable power for an artificial reality headset with a black off-the-shelf coating and an artificial reality headset with an aesthetic black coating, in accordance with one or more embodiments.

FIG. 8 illustrates an example aggregate coating, in accordance with one or more embodiments.

FIG. 9 illustrates an example acoustic echo cancellation performance degradation caused by a sample clock offset, in accordance with one or more embodiments.

FIG. 10A illustrates an example system with a distributed clocking scenario, in accordance with one or more embodiments.

FIG. 10B illustrates an example master-slave arrangement for an audio system using a precision time protocol for clock synchronization, in accordance with one or more embodiments.

FIG. 10C illustrates an example configuration of an audio system with an accessory device operating as a master device for creating a common clock domain, in accordance with one or more embodiments.

FIG. 10D illustrates an example configuration of an audio system with an accessory device operating as a slave device for creating a common clock domain, in accordance with one or more embodiments.

FIG. 11 is a flowchart illustrating a process for performing a battery power-based control of an in-call experience based on shared battery power information at a client device, in accordance with one or more embodiments, in accordance with one or more embodiments.

FIG. 12 depicts a block diagram of a system that includes a headset, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Embodiments of the present disclosure relate to miscellaneous coating, battery, and clock features for artificial reality applications. In some embodiments, a coating that presents as a particular color has increased reflective cooling for solar flux (e.g., ultraviolet (UV) into near-infrared (NIR)), while having high emissivity in the mid-to-far infrared (IR) (e.g., heat emitted by a device). A substrate (e.g., device frame) may be coated via physical vapor deposition (PVD)/polyvinyl chloride (PVC) with a reflective coating (e.g., approximately 2 μm) that is reflective to solar flux and has high emissivity for lower wavelengths. A second ‘color’ coating (paint) may be applied over the reflective coating (e.g., approximately 20 μm) to form an aggregate coating. The second coating may be configured to absorb and/or scatter (e.g., via embedding particles) light in certain bands while being transparent to light outside those bands. In one or more other embodiments, the substrate is composed of ultra-high molecular weight polyethylene (UHMWPE) (e.g., for solar reflectivity). The substrate may be coated with an ultraviolet UV/IR transparent tint coating (e.g., for aesthetics) to form the aggregate coating.

The coating may be on a communication device (e.g., a headset). The communication device includes a battery. In some embodiments, a structural metal five-sided chassis forms a nest for holding the battery. The battery may fit into the nest and may be closed with a cover. A battery fill level may be shared to communication devices on a call to enhance the in-call experience for all parties. For example, if a battery level of the communication device on a call falls below a threshold level, the feeds to/from the device can drop to low power implementations (e.g., reduced frame rate, lower resolution, no augmented reality filters, etc.).

The communication device may be an audio/visual system using high-definition multimedia interface (HDMI) timing for clock synchronization. An audio system may include a primary audio device (or audio/visual device), a dock device, and one or more secondary audio capture devices. The dock device may extract a clock signal from an HDMI signal to create a common clock domain for a precision time protocol (PTP) hardware clock and audio sample clocks for the secondary audio capture devices. The common clock may be synchronous with the audio sample clocks, and once a PTP control look is locked, a PTP primary (primary device)/secondary clock offset may directly provide an audio resampling correction factor. The audio system presented herein may be integrated into, e.g., a headset, a watch, a mobile device, a tablet, etc.

Embodiments of the present disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

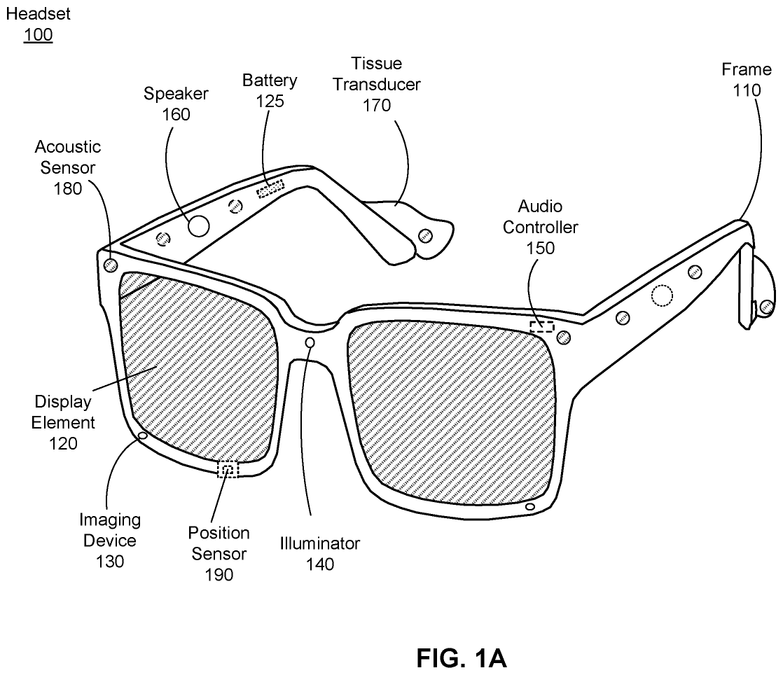

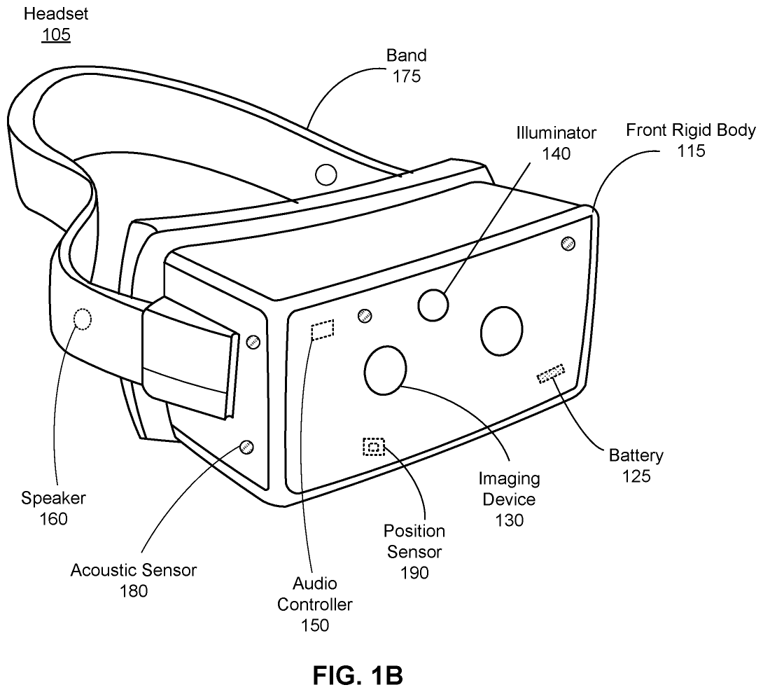

FIG. 1A is a perspective view of a headset 100 implemented as an eyewear device, in accordance with one or more embodiments. In some embodiments, the eyewear device is a near eye display (NED). In general, the headset 100 may be worn on the face of a user such that content (e.g., media content) is presented using a display assembly and/or an audio system. However, the headset 100 may also be used such that media content is presented to a user in a different manner. Examples of media content presented by the headset 100 include one or more images, video, audio, or some combination thereof. The headset 100 includes a frame 110, and may include, among other components, a display assembly including one or more display elements 120, a depth camera assembly (DCA), an audio system, a battery 125, and a position sensor 190. While FIG. 1A illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1A.

The frame 110 holds the other components of the headset 100. The frame 110 includes a front part that holds the one or more display elements 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, earpiece).

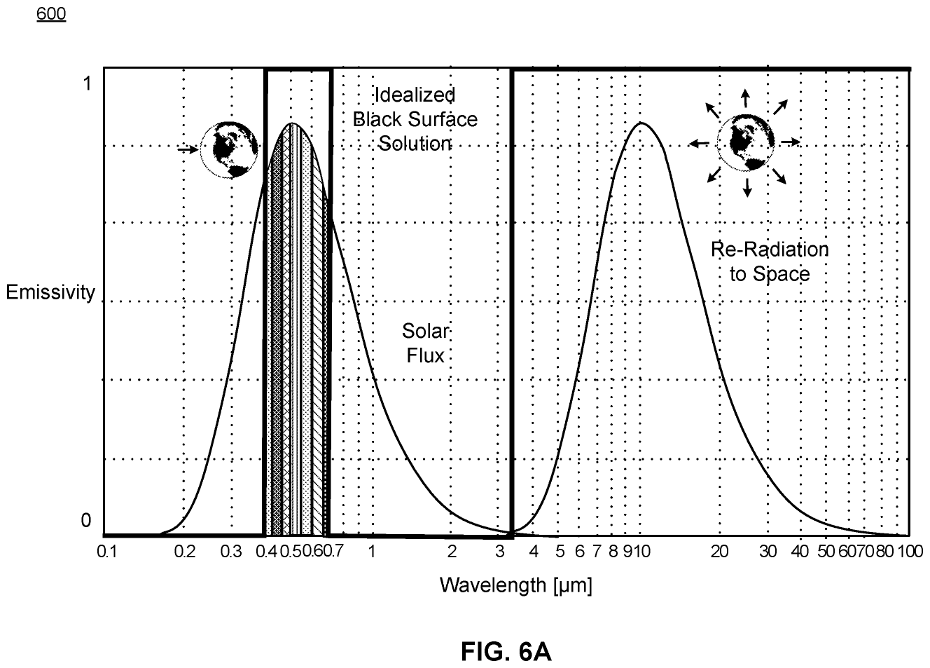

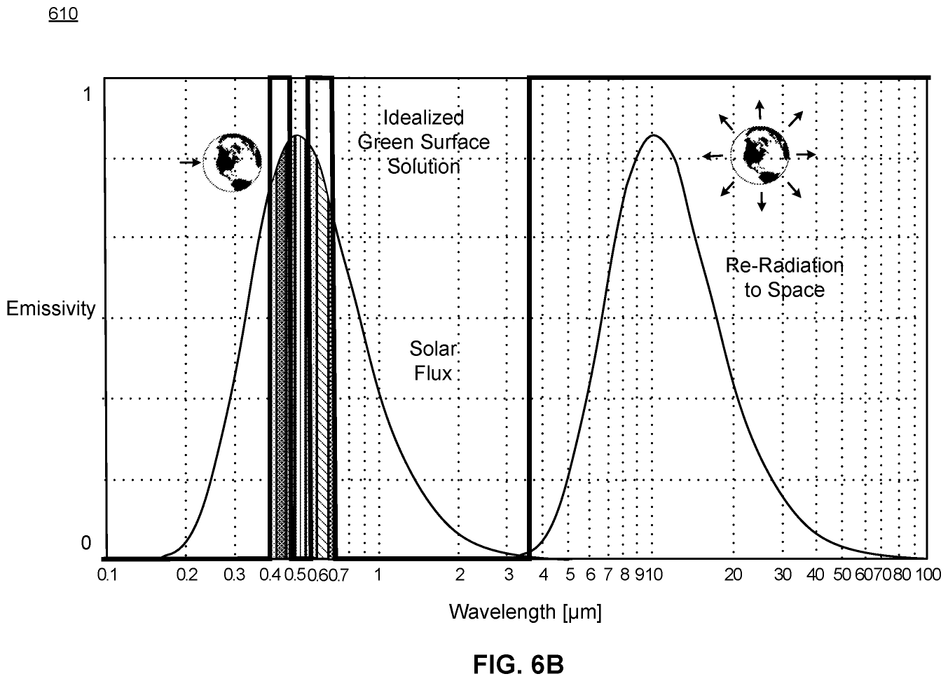

Some embodiments of the present disclosure relate to an (aggregate) coating of the frame 110 that is designed as a solar heat reflective and device radiative aesthetic coating. Details about the (aggregated) coating of the frame 110 are provided below in conjunction with FIGS. 6A through 8.

The one or more display elements 120 provide light to a user wearing the headset 100. As illustrated in FIG. 1A, the headset includes a display element 120 for each eye of a user. In some embodiments, a display element 120 generates image light that is provided to an eye box of the headset 100. The eye box is a location in space that an eye of the user occupies while wearing the headset 100. For example, a display element 120 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eye box of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 120 are at least partially transparent, such that light from the local area may be combined with light from the one or more display elements to produce AR and/or MR content.

In some embodiments, a display element 120 does not generate image light, and instead is a lens that transmits light from the local area to the eye box. For example, one or both of the display elements 120 may be a lens without correction (non-prescription) or a prescription lens (e.g., single vision, bifocal and trifocal, or progressive) to help correct for defects in a user's eyesight. In some embodiments, the display element 120 may be polarized and/or tinted to protect the user's eyes from the sun.

In some embodiments, the display element 120 may include an additional optics block (not shown). The optics block may include one or more optical elements (e.g., lens, Fresnel lens, etc.) that direct light from the display element 120 to the eye box. The optics block may, e.g., correct for aberrations in some or all of the image content, magnify some or all of the image, or some combination thereof.

The DCA determines depth information for a portion of a local area surrounding the headset 100. The DCA includes one or more imaging devices 130 and a DCA controller (not shown in FIG. 1A), and may also include an illuminator 140. In some embodiments, the illuminator 140 illuminates a portion of the local area with light. The light may be, e.g., structured light (e.g., dot pattern, bars, etc.) in the infrared (IR), IR flash for time-of-flight, etc.

In some embodiments, the one or more imaging devices 130 capture images of the portion of the local area that include the light from the illuminator 140. As illustrated, FIG. 1A shows a single illuminator 140 and two imaging devices 130. In alternate embodiments, there is no illuminator 140 and at least two imaging devices 130.

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 140), some other technique to determine depth of a scene, or some combination thereof

The audio system provides audio content. The audio system includes a transducer array, a sensor array, and an audio controller 150. However, in other embodiments, the audio system may include different and/or additional components. Similarly, in some cases, functionality described with reference to the components of the audio system can be distributed among the components in a different manner than is described here. For example, some or all of the functions of the audio controller 150 may be performed by a remote server.

The transducer array presents sound to user. The transducer array includes a plurality of transducers. A transducer may be a speaker 160 or a tissue transducer 170 (e.g., a bone conduction transducer or a cartilage conduction transducer). Although the speakers 160 are shown exterior to the frame 110, the speakers 160 may be enclosed in the frame 110. The tissue transducer 170 couples to the head of the user and directly vibrates tissue (e.g., bone or cartilage) of the user to generate sound. In accordance with embodiments of the present disclosure, the transducer array comprises two transducers (e.g.., two speakers 160, two tissue transducers 170, or one speaker 160 and one tissue transducer 170), i.e., one transducer for each ear. The locations of transducers may be different from what is shown in FIG. 1A.

The sensor array detects sounds within the local area of the headset 100. The sensor array includes a plurality of acoustic sensors 180. An acoustic sensor 180 captures sounds emitted from one or more sound sources in the local area (e.g., a room). Each acoustic sensor is configured to detect sound and convert the detected sound into an electronic format (analog or digital). The acoustic sensors 180 may be acoustic wave sensors, microphones, sound transducers, or similar sensors that are suitable for detecting sounds.

In some embodiments, one or more acoustic sensors 180 may be placed in an ear canal of each ear (e.g., acting as binaural microphones). In some embodiments, the acoustic sensors 180 may be placed on an exterior surface of the headset 100, placed on an interior surface of the headset 100, separate from the headset 100 (e.g., part of some other device), or some combination thereof. The number and/or locations of acoustic sensors 180 may be different from what is shown in FIG. 1A. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset 100.

The audio controller 150 processes information from the sensor array that describes sounds detected by the sensor array. The audio controller 150 may comprise a processor and a non-transitory computer-readable storage medium. The audio controller 150 may be configured to generate direction of arrival (DOA) estimates, generate acoustic transfer functions (e.g., array transfer functions and/or head-related transfer functions), track the location of sound sources, form beams in the direction of sound sources, classify sound sources, generate sound filters for the speakers 160, or some combination thereof.

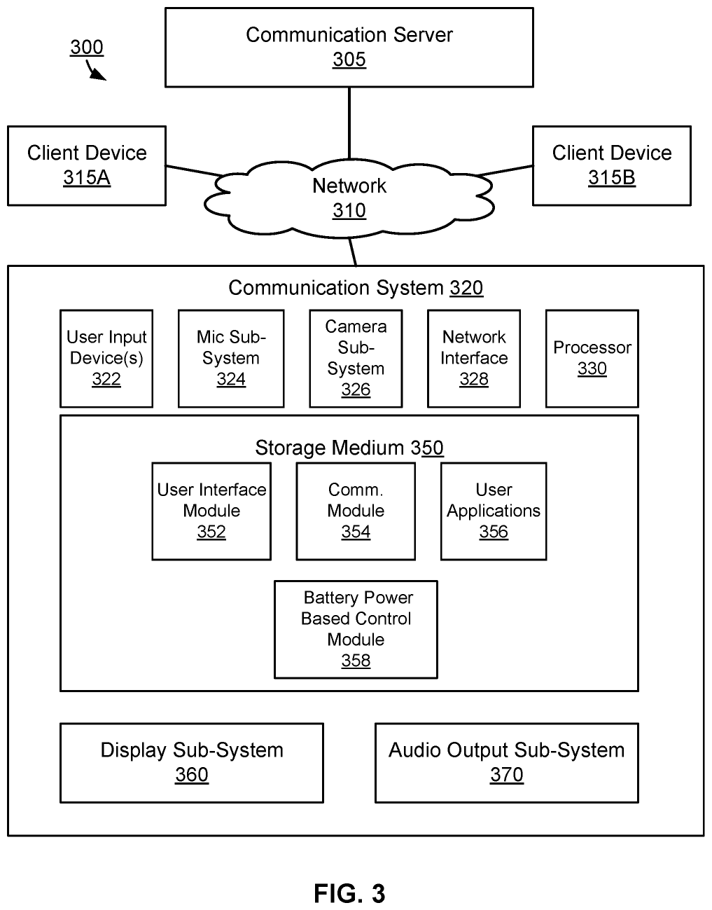

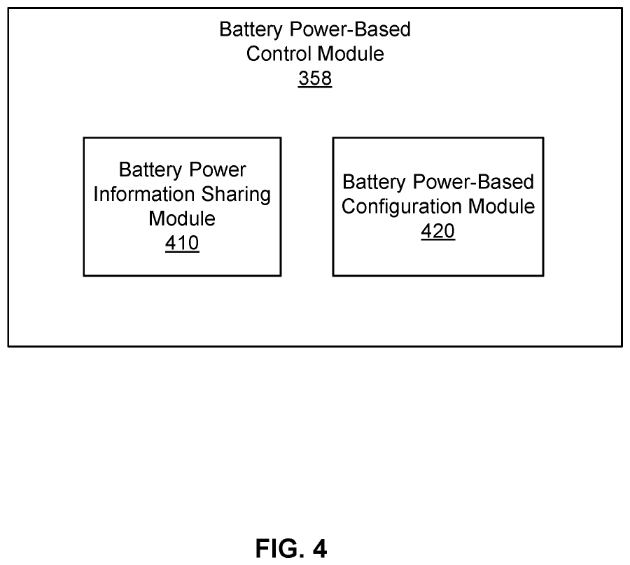

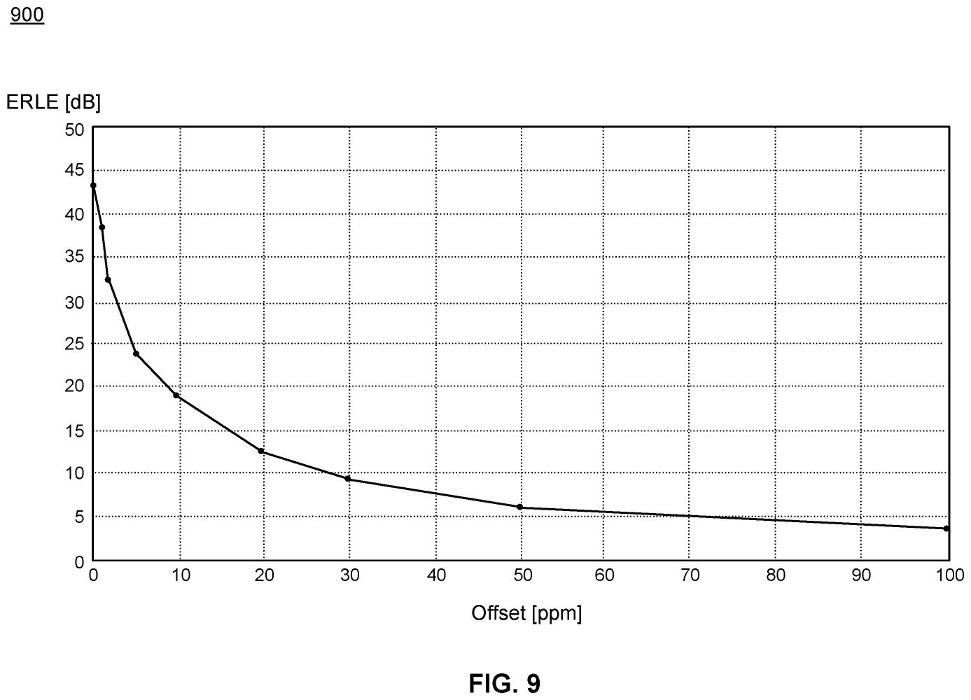

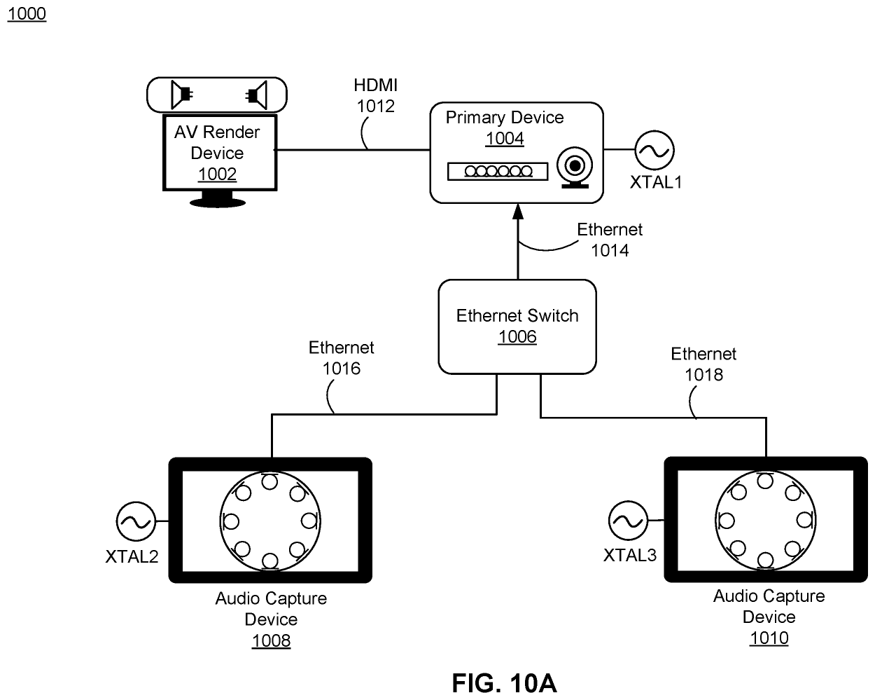

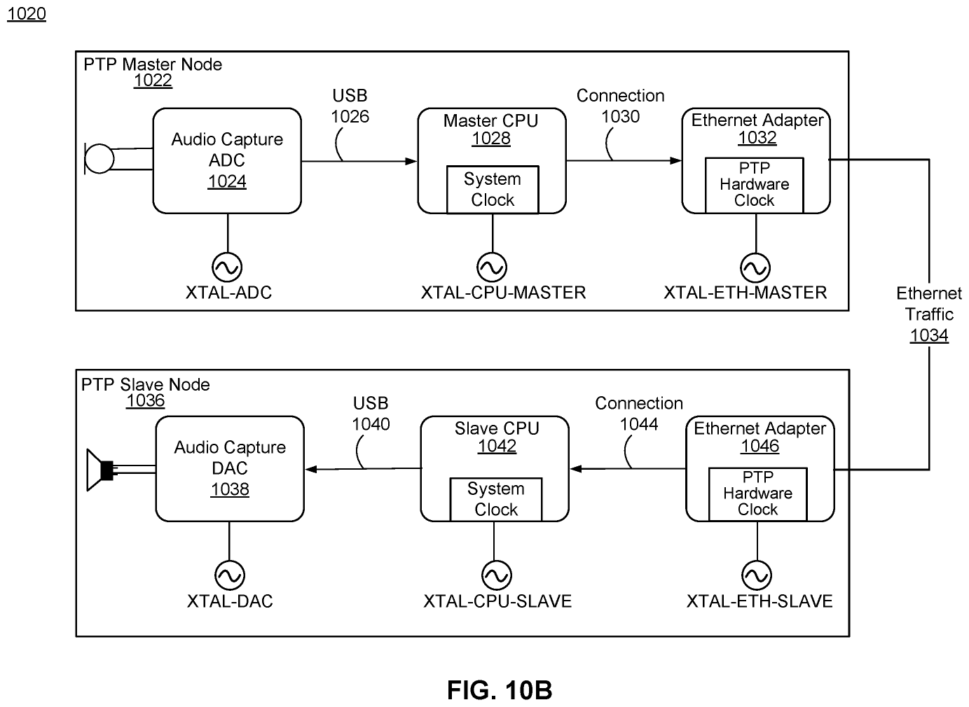

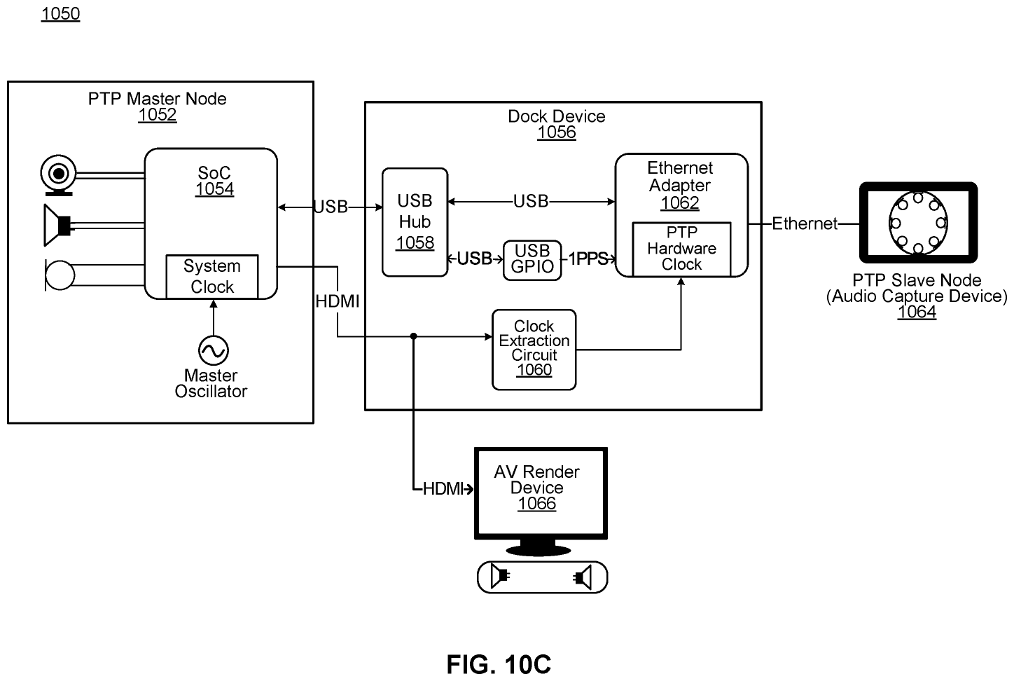

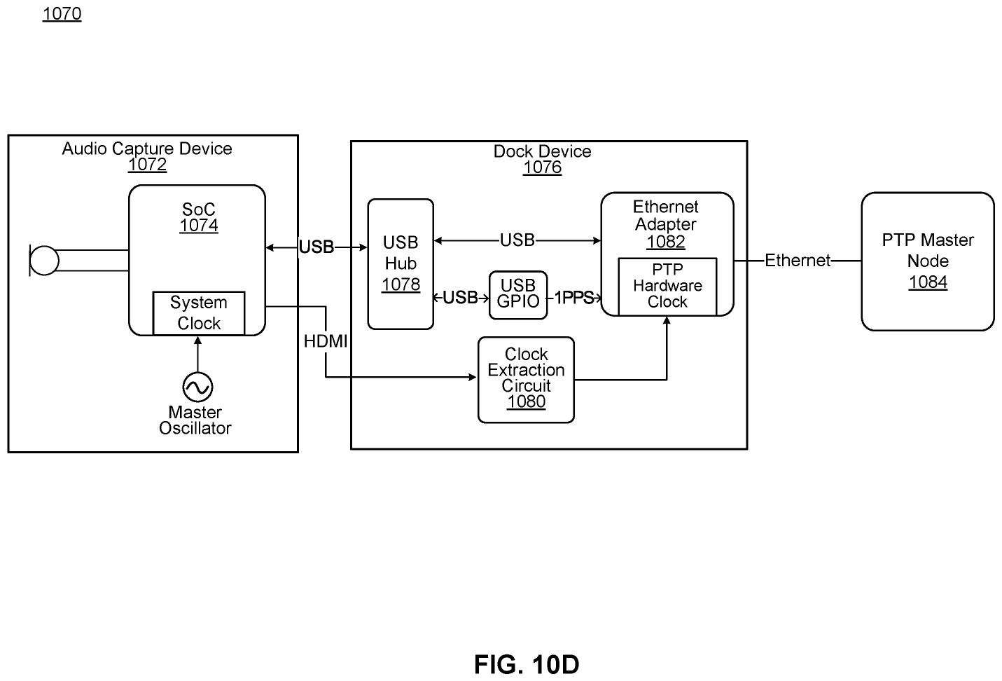

In some embodiments, the audio controller 150 performs (e.g., as described below in conjunction with FIG. 3 and FIG. 4) a battery power-based control of an in-call experience based on shared battery power information. In some other embodiments, the audio controller 150 derives (e.g., as described below in conjunction with FIG. 9 and FIGS. 10A-10D) a network timing for distributed audio-video synchronization.

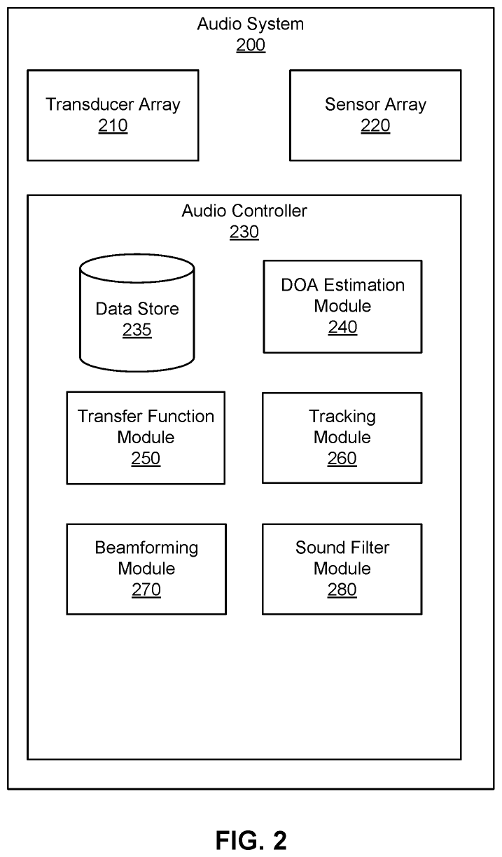

In some embodiments, the audio system is fully integrated into the headset 100. In some other embodiments, the audio system is distributed among multiple devices, such as between a computing device (e.g., smart phone or a console) and the headset 100. The computing device may be interfaced (e.g., via a wired or wireless connection) with the headset 100. In such cases, some of the processing steps presented herein may be performed at a portion of the audio system integrated into the computing device. For example, one or more functions of the audio controller 150 may be implemented at the computing device. More details about the structure and operations of the audio system are described in connection with FIG. 2.

The position sensor 190 generates one or more measurement signals in response to motion of the headset 100. The position sensor 190 may be located on a portion of the frame 110 of the headset 100. The position sensor 190 may include an IMU. Examples of position sensor 190 include: one or more accelerometers, one or more gyroscopes, one or more magnetometers, another suitable type of sensor that detects motion, a type of sensor used for error correction of the IMU, or some combination thereof. The position sensor 190 may be located external to the IMU, internal to the IMU, or some combination thereof.

The audio system can use positional information describing the headset 100 (e.g., from the position sensor 190) to update virtual positions of sound sources so that the sound sources are positionally locked relative to the headset 100. In this case, when the user wearing the headset 100 turns their head, virtual positions of the virtual sources move with the head. Alternatively, virtual positions of the virtual sources are not locked relative to an orientation of the headset 100. In this case, when the user wearing the headset 100 turns their head, apparent virtual positions of the sound sources would not change.

The battery 125 may provide power to various components of the headset 100. The battery 125 may be a rechargeable battery (e.g., lithium rechargeable battery). The battery 125 may provide power to, e.g., the display element 120, the imaging device 130, the illuminator 140, the audio controller 150, the speaker 160, the tissue transducer 170, the acoustic sensor 180, and/or the position sensor 190.

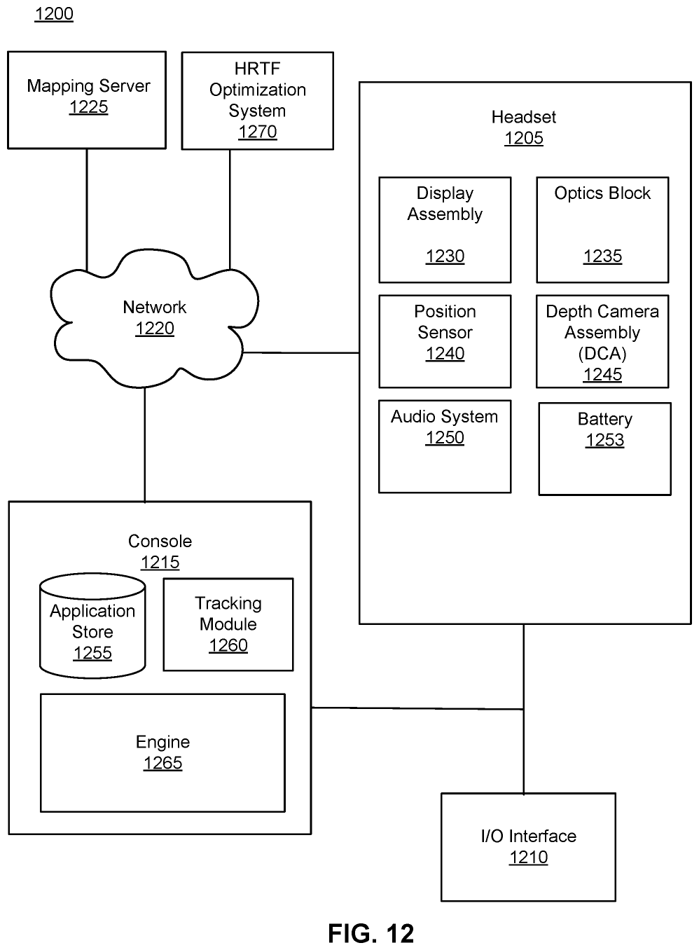

In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA and the depth information determined by the DCA may be used to determine parameters of the local area, generate a model of the local area, update a model of the local area, or some combination thereof. Furthermore, the position sensor 190 tracks the position (e.g., location and pose) of the headset 100 within the room. Additional details regarding the components of the headset 100 are discussed below in connection with FIG. 2 and FIG. 12.

FIG. 1B is a perspective view of a headset 105 implemented as a head-mounted display (HMD), in accordance with one or more embodiments. In embodiments that describe an AR system and/or a MR system, portions of a front side of the HMD are at least partially transparent in the visible band (˜380 nm to 750 nm), and portions of the HMD that are between the front side of the HMD and an eye of the user are at least partially transparent (e.g., a partially transparent electronic display). The HMD includes a front rigid body 115 and a band 175. The headset 105 includes many of the same components described above with reference to FIG. 1A, but modified to integrate with the HMD form factor. For example, the HMD includes a display assembly, a DCA, an audio system, and a position sensor 190. FIG. 1B shows the battery 125, the illuminator 140, a plurality of the speakers 160, a plurality of the imaging devices 130, a plurality of acoustic sensors 180, and the position sensor 190. The speakers 160 may be located in various locations, such as coupled to the band 175 (as shown), coupled to the front rigid body 115, or may be configured to be inserted within the ear canal of a user.

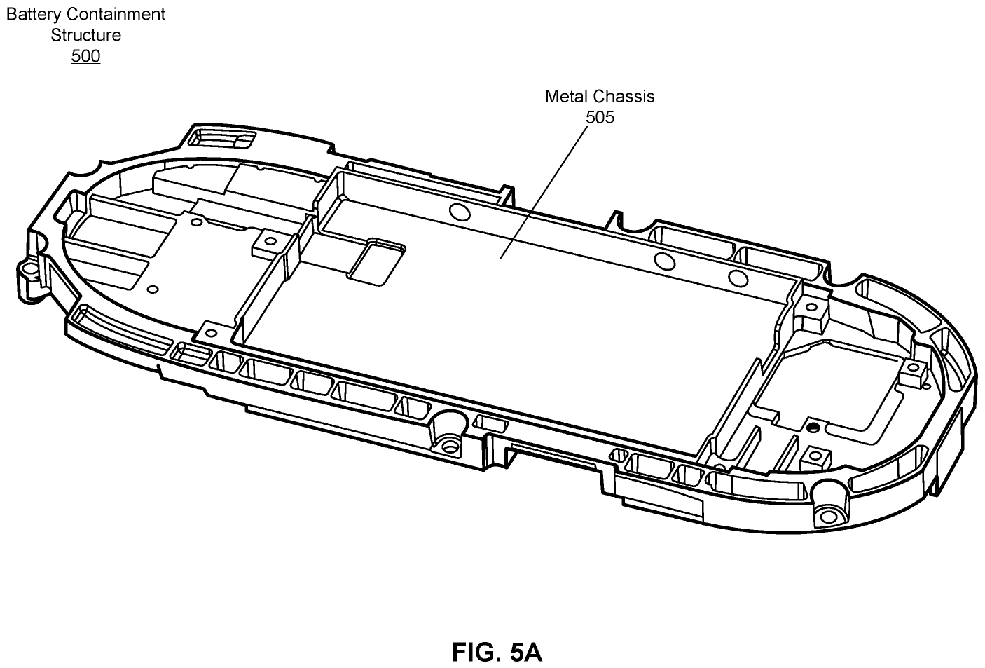

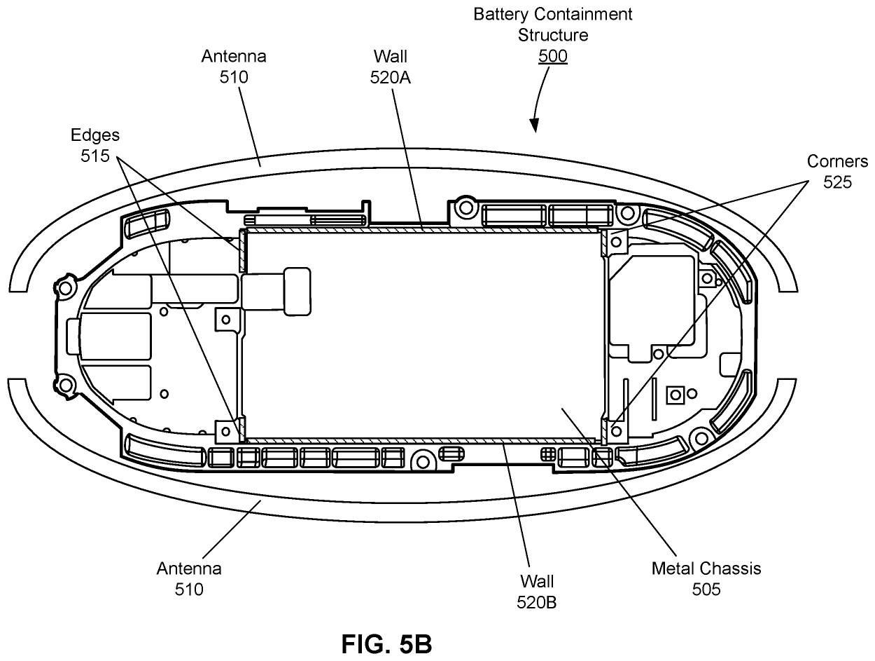

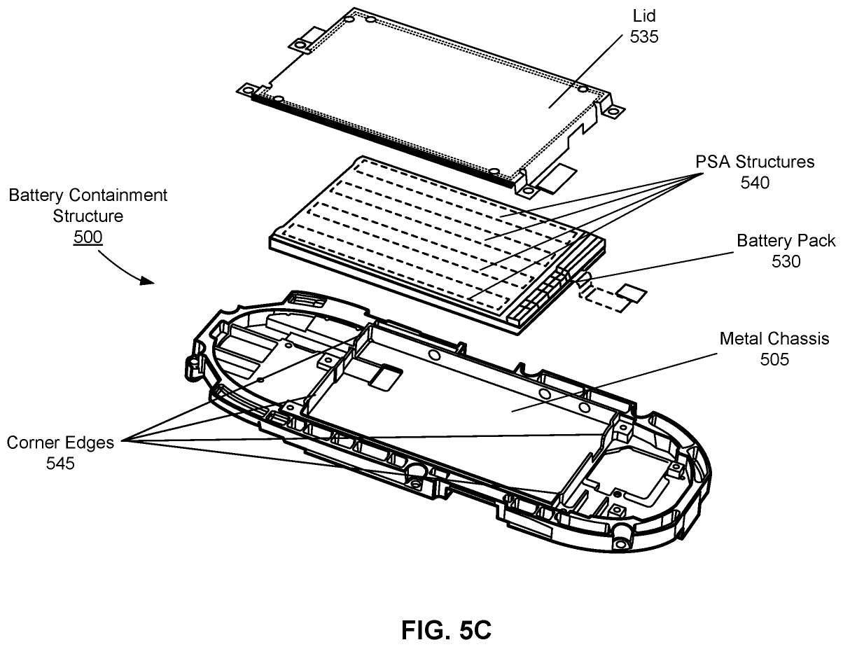

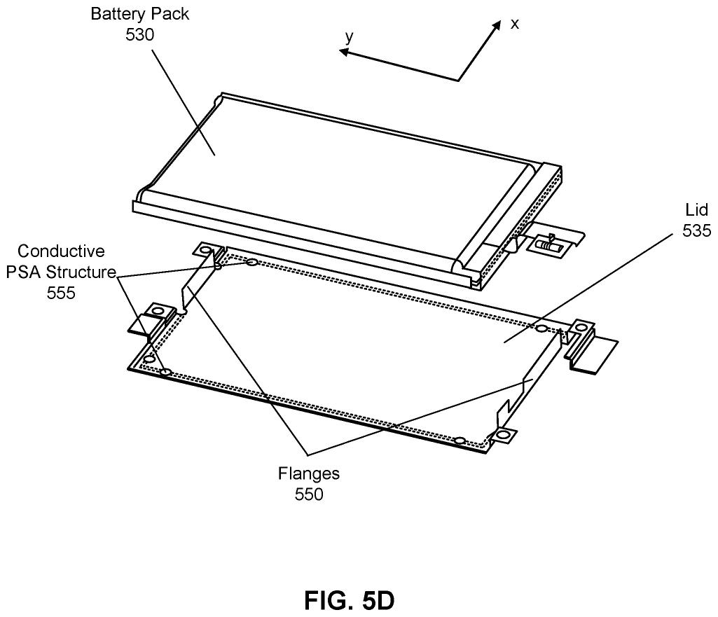

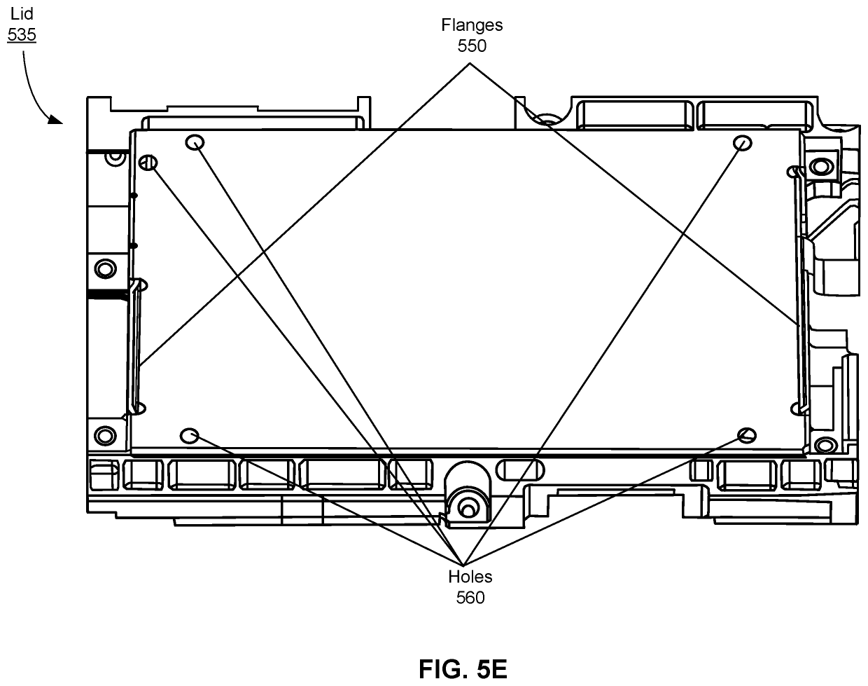

Some embodiments of the present disclosure relate to a battery containment structure for receiving the battery 125 of the headset 105. The battery containment structure may include a metal chassis having surfaces coated with electrical insulators configured to receive the battery 125, and a lid coupled to the metal chassis. More details about implementation of the battery containment structure for the battery 125 are provided below in conjunction with FIGS. 5A-5E.

FIG. 2 is a block diagram of an audio system 200, in accordance with one or more embodiments. The audio system in FIG. 1A or FIG. 1B may be an embodiment of the audio system 200. The audio system 200 generates one or more acoustic transfer functions for a user. The audio system 200 may then use the one or more acoustic transfer functions to generate audio content for the user. In the embodiment of FIG. 2, the audio system 200 includes a transducer array 210, a sensor array 220, and an audio controller 230. Some embodiments of the audio system 200 have different components than those described here. Similarly, in some cases, functions can be distributed among the components in a different manner than is described here.

The transducer array 210 is configured to present audio content. The transducer array 210 includes a pair of transducers, i.e., one transducer for each ear. A transducer is a device that provides audio content. A transducer may be, e.g., a speaker (e.g., the speaker 160), a tissue transducer (e.g., the tissue transducer 170), some other device that provides audio content, or some combination thereof. A tissue transducer may be configured to function as a bone conduction transducer or a cartilage conduction transducer. The transducer array 210 may present audio content via air conduction (e.g., via one or two speakers), via bone conduction (via one or two bone conduction transducer), via cartilage conduction audio system (via one or two cartilage conduction transducers), or some combination thereof.

The bone conduction transducers generate acoustic pressure waves by vibrating bone/tissue in the user's head. A bone conduction transducer may be coupled to a portion of a headset, and may be configured to be behind the auricle coupled to a portion of the user's skull. The bone conduction transducer receives vibration instructions from the audio controller 230, and vibrates a portion of the user's skull based on the received instructions. The vibrations from the bone conduction transducer generate a tissue-borne acoustic pressure wave that propagates toward the user's cochlea, bypassing the eardrum.

The cartilage conduction transducers generate acoustic pressure waves by vibrating one or more portions of the auricular cartilage of the ears of the user. A cartilage conduction transducer may be coupled to a portion of a headset, and may be configured to be coupled to one or more portions of the auricular cartilage of the ear. For example, the cartilage conduction transducer may couple to the back of an auricle of the ear of the user. The cartilage conduction transducer may be located anywhere along the auricular cartilage around the outer ear (e.g., the pinna, the tragus, some other portion of the auricular cartilage, or some combination thereof). Vibrating the one or more portions of auricular cartilage may generate: airborne acoustic pressure waves outside the ear canal; tissue born acoustic pressure waves that cause some portions of the ear canal to vibrate thereby generating an airborne acoustic pressure wave within the ear canal; or some combination thereof. The generated airborne acoustic pressure waves propagate down the ear canal toward the ear drum.

The transducer array 210 generates audio content in accordance with instructions from the audio controller 230. In some embodiments, the audio content is spatialized. Spatialized audio content is audio content that appears to originate from a particular direction and/or target region (e.g., an object in the local area and/or a virtual object). For example, spatialized audio content can make it appear that sound is originating from a virtual singer across a room from a user of the audio system 200. The transducer array 210 may be coupled to a wearable device (e.g., the headset 100 or the headset 105). In alternate embodiments, the transducer array 210 may be a pair of speakers that are separate from the wearable device (e.g., coupled to an external console).

The sensor array 220 detects sounds within a local area surrounding the sensor array 220. The sensor array 220 may include a plurality of acoustic sensors that each detect air pressure variations of a sound wave and convert the detected sounds into an electronic format (analog or digital). The plurality of acoustic sensors may be positioned on a headset (e.g., headset 100 and/or the headset 105), on a user (e.g., in an ear canal of the user), on a neckband, or some combination thereof. An acoustic sensor may be, e.g., a microphone, a vibration sensor, an accelerometer, or any combination thereof In some embodiments, the sensor array 220 is configured to monitor the audio content generated by the transducer array 210 using at least some of the plurality of acoustic sensors. Increasing the number of sensors may improve the accuracy of information (e.g., directionality) describing a sound field produced by the transducer array 210 and/or sound from the local area.

The audio controller 230 controls operation of the audio system 200. In the embodiment of FIG. 2, the audio controller 230 includes a data store 235, a DOA estimation module 240, a transfer function module 250, a tracking module 260, a beamforming module 270, and a sound filter module 280. The audio controller 230 may be located inside a headset, in some embodiments. Some embodiments of the audio controller 230 have different components than those described here. Similarly, functions can be distributed among the components in different manners than described here. For example, some functions of the audio controller 230 may be performed external to the headset. The user may opt in to allow the audio controller 230 to transmit data captured by the headset to systems external to the headset, and the user may select privacy settings controlling access to any such data.

In some embodiments, one or more components of the audio controller 230 perform (e.g., as described below in conjunction with FIG. 3 and FIG. 4) a battery power-based control of an in-call experience based on shared battery power information. In some other embodiments, one or more components of the audio controller 150 derives (e.g., as described below in conjunction with FIG. 9 and FIGS. 10A-10D) a network timing for distributed audio-video synchronization.

The data store 235 stores data for use by the audio system 200. Data in the data store 235 may include sounds recorded in the local area of the audio system 200, audio content, HRTFs, transfer functions for one or more sensors, array transfer functions (ATFs) for one or more of the acoustic sensors, sound source locations, virtual model of local area, direction of arrival estimates, sound filters, virtual positions of sound sources, multi-source audio signals, signals for transducers (e.g., speakers) for each ear, and other data relevant for use by the audio system 200, or any combination thereof. The data store 235 may be implemented as a non-transitory computer-readable storage medium.

The user may opt-in to allow the data store 235 to record data captured by the audio system 200. In some embodiments, the audio system 200 may employ always on recording, in which the audio system 200 records all sounds captured by the audio system 200 in order to improve the experience for the user. The user may opt in or opt out to allow or prevent the audio system 200 from recording, storing, or transmitting the recorded data to other entities.

The DOA estimation module 240 is configured to localize sound sources in the local area based in part on information from the sensor array 220. Localization is a process of determining where sound sources are located relative to the user of the audio system 200. The DOA estimation module 240 performs a DOA analysis to localize one or more sound sources within the local area. The DOA analysis may include analyzing the intensity, spectra, and/or arrival time of each sound at the sensor array 220 to determine the direction from which the sounds originated. In some cases, the DOA analysis may include any suitable algorithm for analyzing a surrounding acoustic environment in which the audio system 200 is located.

For example, the DOA analysis may be designed to receive input signals from the sensor array 220 and apply digital signal processing algorithms to the input signals to estimate a direction of arrival. These algorithms may include, for example, delay and sum algorithms where the input signal is sampled, and the resulting weighted and delayed versions of the sampled signal are averaged together to determine a DOA. A least mean squared (LMS) algorithm may also be implemented to create an adaptive filter. This adaptive filter may then be used to identify differences in signal intensity, for example, or differences in time of arrival. These differences may then be used to estimate the DOA. In another embodiment, the DOA may be determined by converting the input signals into the frequency domain and selecting specific bins within the time-frequency (TF) domain to process. Each selected TF bin may be processed to determine whether that bin includes a portion of the audio spectrum with a direct path audio signal. Those bins having a portion of the direct-path signal may then be analyzed to identify the angle at which the sensor array 220 received the direct-path audio signal. The determined angle may then be used to identify the DOA for the received input signal. Other algorithms not listed above may also be used alone or in combination with the above algorithms to determine DOA.

In some embodiments, the DOA estimation module 240 may also determine the DOA with respect to an absolute position of the audio system 200 within the local area. The position of the sensor array 220 may be received from an external system (e.g., some other component of a headset, an artificial reality console, a mapping server, a position sensor (e.g., the position sensor 190, etc.). The external system may create a virtual model of the local area, in which the local area and the position of the audio system 200 are mapped. The received position information may include a location and/or an orientation of some or all of the audio system 200 (e.g., of the sensor array 220). The DOA estimation module 240 may update the estimated DOA based on the received position information.

The transfer function module 250 is configured to generate one or more acoustic transfer functions. Generally, a transfer function is a mathematical function giving a corresponding output value for each possible input value. Based on parameters of the detected sounds, the transfer function module 250 generates one or more acoustic transfer functions associated with the audio system. The acoustic transfer functions may be ATFs, HRTFs, other types of acoustic transfer functions, or some combination thereof. An ATF characterizes how the microphone receives a sound from a point in space.

An ATF includes a number of transfer functions that characterize a relationship between the sound source and the corresponding sound received by the acoustic sensors in the sensor array 220. Accordingly, for a sound source there is a corresponding transfer function for each of the acoustic sensors in the sensor array 220. And collectively the set of transfer functions is referred to as an ATF. Accordingly, for each sound source there is a corresponding ATF. Note that the sound source may be, e.g., someone or something generating sound in the local area, the user, or one or more transducers of the transducer array 210. The ATF for a particular sound source location relative to the sensor array 220 may differ from user to user due to a person's anatomy (e.g., ear shape, shoulders, etc.) that affects the sound as it travels to the person's ears. Accordingly, the ATFs of the sensor array 220 are personalized for each user of the audio system 200.

In some embodiments, the transfer function module 250 determines one or more HRTFs for a user of the audio system 200. The HRTF characterizes how an ear receives a sound from a point in space. The HRTF for a particular source location relative to a person is unique to each ear of the person (and is unique to the person) due to the person's anatomy (e.g., ear shape, shoulders, etc.) that affects the sound as it travels to the person's ears. In some embodiments, the transfer function module 250 may determine HRTFs for the user using a calibration process. In some embodiments, the transfer function module 250 may provide information about the user to a remote system. The user may adjust privacy settings to allow or prevent the transfer function module 250 from providing the information about the user to any remote systems. The remote system determines a set of HRTFs that are customized to the user using, e.g., machine learning, and provides the customized set of HRTFs to the audio system 200.

The tracking module 260 is configured to track locations of one or more sound sources. The tracking module 260 may compare current DOA estimates and compare them with a stored history of previous DOA estimates. In some embodiments, the audio system 200 may recalculate DOA estimates on a periodic schedule, such as once per second, or once per millisecond. The tracking module may compare the current DOA estimates with previous DOA estimates, and in response to a change in a DOA estimate for a sound source, the tracking module 260 may determine that the sound source moved. In some embodiments, the tracking module 260 may detect a change in location based on visual information received from the headset or some other external source. The tracking module 260 may track the movement of one or more sound sources over time. The tracking module 260 may store values for a number of sound sources and a location of each sound source at each point in time. In response to a change in a value of the number or locations of the sound sources, the tracking module 260 may determine that a sound source moved. The tracking module 260 may calculate an estimate of the localization variance. The localization variance may be used as a confidence level for each determination of a change in movement.

The beamforming module 270 is configured to process one or more ATFs to selectively emphasize sounds from sound sources within a certain area while de-emphasizing sounds from other areas. In analyzing sounds detected by the sensor array 220, the beamforming module 270 may combine information from different acoustic sensors to emphasize sound associated from a particular region of the local area while deemphasizing sound that is from outside of the region. The beamforming module 270 may isolate an audio signal associated with sound from a particular sound source from other sound sources in the local area based on, e.g., different DOA estimates from the DOA estimation module 240 and the tracking module 260. The beamforming module 270 may thus selectively analyze discrete sound sources in the local area. In some embodiments, the beamforming module 270 may enhance a signal from a sound source. For example, the beamforming module 270 may apply sound filters which eliminate signals above, below, or between certain frequencies. Signal enhancement acts to enhance sounds associated with a given identified sound source relative to other sounds detected by the sensor array 220.

The sound filter module 280 determines sound filters for the transducer array 210. In some embodiments, the sound filters cause the audio content to be spatialized, such that the audio content appears to originate from a target region. The sound filter module 280 may use HRTFs and/or acoustic parameters to generate the sound filters. The acoustic parameters describe acoustic properties of the local area. The acoustic parameters may include, e.g., a reverberation time, a reverberation level, a room impulse response, etc. In some embodiments, the sound filter module 280 calculates one or more of the acoustic parameters. In some embodiments, the sound filter module 280 requests the acoustic parameters from a mapping server (e.g., as described below with regard to FIG. 12).

The sound filter module 280 provides the sound filters to the transducer array 210. In some embodiments, the sound filters may cause positive or negative amplification of sounds as a function of frequency. In some embodiments, audio content presented by the transducer array 210 is multi-channel spatialized audio. Spatialized audio content is audio content that appears to originate from a particular direction and/or target region (e.g., an object in the local area and/or a virtual object). For example, spatialized audio content can make it appear that sound is originating from a virtual singer across a room from a user of the audio system 200.

### Sharing Battery Power Information to Improve In-Call Experience

Embodiments presented herein improve the experience of users who are using individual systems in a call together by sharing information about battery power levels of the individual systems with each other. The shared battery power level information is used in embodiments herein to control configuration settings of various network and user applications being used during the call and thereby control the level of deterioration of the immersive experience for the users. For example, when users at three respective remote systems, system A, system B, and system C, are communicating with each other, after the battery power level in system B falls below a critical threshold, this information may be communicated to system A and system C. This information may be used by system A and system C in a variety of ways, such as, for example: (i) providing an indication to the users of system A and system C, respectively, that a particular shared experience currently in progress with system B may have a particular expected duration based on the battery power level information received from system B; (ii) user applications executing in system A and system C may start encoding media streams that are currently in progress to system B at a lower resolution and/or frame rate, while leaving media streams between system A and system C (i.e., with battery power levels above the prespecified threshold) unchanged; and (iii) user applications currently executing in system A and system C may replace a particular power heavy version of the application with a more power lightweight version of the application, etc. Note that these are merely exemplary and that systems may perform other actions in response to receiving information about the battery power levels falling below a prespecified threshold both in their own systems or in other systems that they may be in communication with. Thus, knowledge of battery power information of another system or communication system may be used to configure communication and user application settings in individual communication systems to control deterioration of the user experience for all the users who are in the call using the individual communication systems.

FIG. 3 is a block diagram of a system environment 300 for a communication system 320, in accordance with one or more embodiments. The system environment 300 includes a communication server 305, one or more client devices 315 (e.g., client devices 315A, 315B), a network 310, and a communication system 320. In alternative configurations, different and/or additional components may be included in the system environment 300. For example, the system environment 300 may include additional client devices 315, additional communication servers 305, or additional communication systems 320.

In an embodiment, the communication system 320 comprises an integrated computing device that operates as a standalone network-enabled client device. In another embodiment, the communication system 320 comprises a computing device for coupling to an external media device such as a television or other external display and/or audio output system. In this embodiment, the communication system 320 may couple to the external media device via a wireless interface or wired interface (e.g., an HDMI cable) and may utilize various functions of the external media device such as its display, speakers, and input devices. Here, the communication system 320 may be configured to be compatible with a generic external media device that does not have specialized software, firmware, or hardware specifically for interacting with the communication system 320.

The client devices 315 may be one or more computing devices capable of receiving user input as well as transmitting and/or receiving data via the network 310. In one embodiment, a client device 315 is a conventional computer system, such as a desktop or a laptop computer. Alternatively, a client device 315 may be a device having computer functionality, such as a personal digital assistant (PDA), a mobile telephone, a smartphone, a tablet, an Internet of Things (IoT) device, a video conferencing device, another instance of the communication system 320, or another suitable device. A client device 315 may be configured to communicate via the network 310. In one embodiment, a client device 315 executes an application allowing a user of the client device 315 to interact with the communication system 320 by enabling voice calls, video calls, data sharing, or other interactions. For example, a client device 315 may execute a browser application to enable interactions between the client device 315 and the communication system 305 via the network 310. In another embodiment, a client device 315 interacts with the communication system 305 through an application running on a native operating system of the client device 315, such as IOS® or ANDROID™.

The communication server 305 may facilitate communications of the client devices 315 and the communication system 320 over the network 310. For example, the communication server 305 may facilitate connections between the communication system 320 and a client device 315 when a voice or video call is requested. Additionally, the communication server 305 may control access of the communication system 320 to various external applications or services available over the network 310. In an embodiment, the communication server 305 provides updates to the communication system 320 when new versions of software or firmware become available. In other embodiments, various functions described below as being attributed to the communication system 320 can instead be performed entirely or in part on the communication server 305. For example, in some embodiments, various processing or storage tasks are offloaded from the communication system 320 and instead performed on the communication server 305.

The network 310 may comprise any combination of local area and/or wide area networks, using wired and/or wireless communication systems. In one embodiment, the network 310 uses standard communications technologies and/or protocols. For example, the network 310 may include communication links using technologies such as Ethernet, 802.11 (WiFi), worldwide interoperability for microwave access (WiMAX), 3G, 4G, 5G, code division multiple access (CDMA), digital subscriber line (DSL), Bluetooth, Near Field Communication (NFC), Universal Serial Bus (USB), or any combination of protocols. In some embodiments, all or some of the communication links of the network 310 are encrypted using any suitable technique or techniques.

The communication system 320 may include one or more user input devices 322, a microphone sub-system 324, a camera sub-system 326, a network interface 328, a processor 330, a storage medium 350, a display sub-system 360, and an audio sub-system 370. In other embodiments, the communication system 320 includes additional, fewer, or different components.

The user input device 322 may comprise hardware that enables a user to interact with the communication system 320. The user input device 322 can comprise, for example, a touchscreen interface, a game controller, a keyboard, a mouse, a joystick, a voice command controller, a gesture recognition controller, a remote control receiver, or other input device. In an embodiment, the user input device 322 includes a remote control device that is physically separate from the user input device 322 and interacts with a remote controller receiver (e.g., an infrared (IR) or other wireless receiver) that may be integrated with or otherwise connected to the communication system 320. In some embodiments, the display sub-system 360 and the user input device 322 are integrated together, such as in a touchscreen interface. In other embodiments, user inputs are received over the network 310 from a client device 315. For example, an application executing on a client device 315 may send commands over the network 310 to control the communication system 320 based on user interactions with the client device 315. In other embodiments, the user input device 322 includes a port (e.g., an HDMI port) connected to an external television that enables user inputs to be received from the television responsive to user interactions with an input device of the television. For example, the television may send user input commands to the communication system 320 via a Consumer Electronics Control (CEC) protocol based on user inputs received by the television.

The microphone sub-system 324 may comprise one or more microphones (or connections to external microphones) that capture ambient audio signals by converting sound into electrical signals that can be stored or processed by other components of the communication system 320. The captured audio signals may be transmitted to the client devices 315 during an audio/video call or in an audio/video message. Additionally, the captured audio signals may be processed to identify voice commands for controlling functions of the communication system 320. In an embodiment, the microphone sub-system 324 comprises one or more integrated microphones. Alternatively, the microphone sub-system 324 may comprise an external microphone coupled to the communication system 320 via a communication link (e.g., the network 310 or other direct communication link). The microphone sub-system 324 may comprise a single microphone or an array of microphones. In the case of a microphone array, the microphone sub-system 324 may process audio signals from multiple microphones to generate one or more beamformed audio channels (or beams) each associated with a particular direction (or range of directions).

The camera sub-system 326 may comprise one or more cameras (or connections to one or more external cameras) that captures images and/or video signals. The captured images or video may be sent to the client device 315 during a video call or in a multimedia message or may be stored or processed by other components of the communication system 320. Furthermore, in an embodiment, images or video from the camera sub-system 326 can be processed for object detection, human detection, face detection, face recognition, gesture recognition, or other information that may be utilized to control functions of the communication system 320. Here, an estimated position in three-dimensional space of a detected entity (e.g., a target listener) in an image frame may be outputted by the camera sub-system 326 in association with the image frame and may be utilized by other components of the communication system 320 as described below. In an embodiment, the camera sub-system 326 includes one or more wide-angle cameras for capturing a wide, panoramic, or spherical field of view of a surrounding environment. The camera sub-system 326 may include integrated processing to stitch together images from multiple cameras, or to perform image processing functions such as zooming, panning, de-warping, or other functions. In an embodiment, the camera sub-system 326 includes multiple cameras positioned to capture stereoscopic (e.g., three-dimensional images) or includes a depth camera to capture depth values for pixels in the captured images or video.

The network interface 328 may facilitate connection of the communication system 320 to the network 310. For example, the network interface 328 may include software and/or hardware that facilitates communication of voice, video, and/or other data signals with one or more client devices 315 to enable voice and video calls or other operation of various applications executing on the communication system 320. The network interface 328 may operate according to any conventional wired or wireless communication protocols that enable it to communication over the network 310.

The display sub-system 360 may comprise an electronic device or an interface to an electronic device for presenting images or video content. For example, the display sub-system 360 may comprises an LED display panel, an LCD display panel, a projector, a virtual reality headset, an augmented reality headset, another type of display device, or an interface for connecting to any of the above-described display devices. In an embodiment, the display sub-system 360 includes a display that is integrated with other components of the communication system 320. Alternatively, the display sub-system 360 may comprise one or more ports (e.g., an HDMI port) that couples the communication system to an external display device (e.g., a television).

The audio output sub-system 370 may comprise one or more speakers or an interface for coupling to one or more external speakers that generate ambient audio based on received audio signals. In an embodiment, the audio output sub-system 370 includes one or more speakers integrated with other components of the communication system 320. Alternatively, the audio output sub-system 370 may comprise an interface (e.g., an HDMI interface or optical interface) for coupling the communication system 320 with one or more external speakers (e.g., a dedicated speaker system or television). The audio output sub-system 370 may output audio in multiple channels to generate beamformed audio signals that give the listener a sense of directionality associated with the audio. For example, the audio output sub-system 370 may generate audio output as a stereo audio output or a multi-channel audio output such as 2.1, 3.1, 5.1, 7.1, or any other standard configuration.

The depth sensor sub-system 380 may comprise one or more depth sensors or an interface for coupling to one or more external depth sensors that detect depths of objects in physical spaces surrounding the communication system 320. In an embodiment, the depth sensor sub-system 380 is a part of the camera sub-system 326 or receives information gathered from the camera sub-system to evaluate depths of objects in physical spaces. In another embodiment, the depth sensor sub-system 380 includes one or more sensors integrated with other components of the communication system 320. Alternatively, the depth sensor sub-system 380 may comprise an interface (e.g., an HDMI port) for coupling the communication system 320 with one or more external depth sensors.

In embodiments in which the communication system 320 is coupled to an external media device such as a television, the communication system 320 lacks an integrated display and/or an integrated speaker. Instead, the communication system 320 may communicate audio/visual data for outputting via a display and speaker system of the external media device.

The processor 330 may operate in conjunction with the storage medium 350 (e.g., a non-transitory computer-readable storage medium) to carry out various functions attributed to the communication system 320 described herein. For example, the storage medium 350 may store one or more modules or applications (e.g., user interface 352, communication module 354, user applications 356) embodied as instructions executable by the processor 330. The instructions, when executed by the processor, cause the processor 330 to carry out the functions attributed to the various modules or applications described herein. In an embodiment, the processor 330 may comprise a single processor or a multi-processor system.

In an embodiment, the storage medium 350 comprises a user interface module 352, a communication module 354, and user applications 356. In alternative embodiments, the storage medium 350 may comprise different or additional components. The storage medium may store information that may be required for the execution of a battery power-based control module 358. The stored information may include battery power sharing user preference/privacy information associated with the communication system 320, information related to power-intensive and power-lightweight user applications, one or more lookup tables for determining encoding parameters such as media resolutions, and frame rates for different remote device battery power levels, etc.

The user interface module 352 may comprise visual and/or audio elements and controls for enabling user interaction with the communication system 320. For example, the user interface module 352 may receive inputs from the user input device 322 to enable the user to select various functions of the communication system 320. In an example embodiment, the user interface module 352 includes a calling interface to enable the communication system 320 to make or receive voice and/or video calls over the network 310. To make a call, the user interface module 352 may provide controls to enable a user to select one or more contacts for calling, to initiate the call, to control various functions during the call, and to end the call. To receive a call, the user interface module 352 may provide controls to enable a user to accept an incoming call, to control various functions during the call, and to end the call. For video calls, the user interface module 352 may include a video call interface that displays remote video from a client 315 together with various control elements such as volume control, an end call control, or various controls relating to how the received video is displayed or the received audio is outputted.

The user interface module 352 may furthermore enable a user to access user applications 356 or to control various settings of the communication system 320. In an embodiment, the user interface module 352 may enable customization of the user interface according to user preferences. Here, the user interface module 352 may store different preferences for different users of the communication system 320 and may adjust settings depending on the current user.

The communication module 354 may facilitate communications of the communication system 320 with clients 315 for voice and/or video calls. For example, the communication module 354 may maintain a directory of contacts and facilitate connections to those contacts in response to commands from the user interface module 352 to initiate a call. Furthermore, the communication module 354 may receive indications of incoming calls and interact with the user interface module 352 to facilitate reception of the incoming call. The communication module 354 may furthermore process incoming and outgoing voice and/or video signals during calls to maintain a robust connection and to facilitate various in-call functions.

The user applications 356 may comprise one or more applications accessible by a user via the user interface module 352 to facilitate various functions of the communication system 320. For example, the user applications 356 may include a web browser for browsing web pages on the Internet, a picture viewer for viewing images, a media playback system for playing video or audio files, an intelligent virtual assistant for performing various tasks or services in response to user requests, or other applications for performing various functions. In an embodiment, the user applications 356 includes a social networking application that enables integration of the communication system 320 with a user's social networking account. Here, for example, the communication system 320 may obtain various information from the user's social networking account to facilitate a more personalized user experience. Furthermore, the communication system 320 can enable the user to directly interact with the social network by viewing or creating posts, accessing feeds, interacting with friends, etc. Additionally, based on the user preferences, the social networking application may facilitate retrieval of various alerts or notifications that may be of interest to the user relating to activity on the social network. In an embodiment, users can add or remove applications 356 to customize operation of the communication system 320.

The battery power-based control module 358 is described below with respect to FIG. 4.

FIG. 4 is a block diagram of a battery power-based control module 358, in accordance with one or more embodiments. The battery power-based control module 358 may include a battery power information sharing module 410 and a battery power-based configuration module 420. In alternative configurations, the battery power-based control module 358 includes different and/or additional modules.

The battery power information sharing module 410 may monitor battery power level information of the communication system 320 and send this information over the network to remote devices participating in a call with the communication system 320. In some embodiments, some or all of the remote devices participating in the call are associated with different call participants. In some embodiments, the power information sharing feature is a privacy-setting based opt-in/opt-out feature to be set by the user of the communication system 320. In some embodiments, the battery power information sharing module 410 sends the information after the battery power level of the communication system 320 falls below a prespecified threshold level. The prespecified threshold may be based on the power requirements for executing networking applications and user applications at a particular level of performance and quality. In some embodiments, there is more than one prespecified threshold level for the battery power level. In some embodiments, when the battery power level of communication system 320 goes back above the prespecified threshold level, such as when the system 320 gets plugged into an energy source or the battery is replaced, the battery power information sharing module 410 stops sending battery information over the network to the remote devices. In some embodiments, the battery power information sharing module 410 sends the battery power information of the communication system 320 to all devices during the call with them, irrespective of the power level. In some embodiments, the battery power information is sent periodically, with a period of transmission that may be configurable by the user of the communication system 320. In some embodiments, the battery power information sharing module 410 sends the battery power information over a Web Real-Time Communication (WebRTC) channel to the remote participating devices in the call. In some embodiments, the battery power information sharing module 410 sends this information periodically at prespecified threshold levels of deterioration of the battery power level.

The battery power information sharing module 410 may receive battery power level information from other remote devices participating in a call with the communication system 320. In some embodiments, the battery power information sharing module 410 receives battery information periodically from all the remote devices in the call. In some embodiments, the battery power information sharing module 410 receives battery information periodically from a remote device subsequent to the power level in the remote device falling below a prespecified threshold. In some embodiments, the battery power information sharing module 410 monitors the received battery power information received from each remote device participating in a call and sends a prompt to the battery power-based configuration module 420 after the monitored power level of a remote device falls below a prespecified threshold. In some embodiments, after the battery power information sharing module 410 determines, through the monitoring, that the power level of the remote device has been restored to above the prespecified threshold levels (for example, after the remote device plugs into an outlet and thereby moves its power level over the threshold), the battery power information sharing module 410 also sends a prompt of the restored power level of the identified remote device to the battery power-based configuration module 420. The prompt sent by the battery power information sharing module 410 to the battery power-based configuration module 420 may include information such as a device identifier, the prespecified threshold that has been met, and percentage power remaining in the identified device, among others.

The battery power-based configuration module 420 may receive a prompt that the battery power level of the communication system 320 is below a prespecified threshold level. In response, the battery power-based configuration module 420 may ensure that any call sharing experience that is triggered with remote devices subsequent to receiving this indication only uses power lightweight features. In some embodiments, when the communication system 320 is in call with other remote devices, and the battery power-based configuration module 420 receives, during the call in progress, a prompt regarding the low battery power level of the system 320 itself, the battery power-based configuration module 420 obtains, from the storage medium 350, a list of all the applications being executed during the call (e.g., AR/VR effects, games, story-time applications, video sharing, music sharing, karaoke, etc.). Subsequently, the battery power-based configuration module 420 may trigger a switchover to lightweight power versions of network and user applications, leading to all the users in the call having a consistent in-call sharing experience with lower power-required applications using lower media resolutions, lower frame rates, and available low power features. In some embodiments, after the battery power-based configuration module 420 receives a prompt that the battery power level of the communication system 320 is below the prespecified threshold level, if the communication system initiates a call with one or more other remote devices, the battery power-based configuration module 420 ensures that certain power intensive user applications that may be otherwise available to the user of the communication system 320 are not on display or available for selection by the user.

The battery power-based configuration module 420 may receive a prompt from the battery power information sharing module 410 that identifies a remote device using an identifier, and provides information about the battery power level of the identified remote device when the battery power level of the identified remote device is below a prespecified threshold level.

In some embodiments, after the battery power-based configuration module 420 receives the prompt identifying the remote device and the low battery power level of the remote device, the battery power-based configuration module 420 causes the user interface module 352 to display information regarding the identified remote device and associated battery power level. The battery power-based configuration module 420 may also cause the user interface module 352 to display other information such as an expected call duration under the current call configuration with the identified remote device. In some embodiments, the battery power-based configuration module 420 also causes the user interface module 352 to display information regarding restored power levels in the identified remote device after such information is received by the battery power information sharing module 410.

In some embodiments, after the battery power-based configuration module 420 receives the prompt identifying the remote device and the low battery power level of the remote device, the battery power-based configuration module 420 causes the user interface module 352 to display information regarding the power levels of remote devices based on the privacy settings of the users at the remote devices. In these embodiments, a user at a device is provided a privacy opt-in/opt-out feature regarding the device sharing battery power levels with other remote devices during a call with the other remote devices. When a user at a particular device opts in to sharing the battery power information with other devices, then the battery power information of the particular device may be shared with other remote devices. Similarly, the user at the particular device may also be offered an opt-in/opt out feature regarding notifying other users about the shared battery information. When the user at the particular device opts in regarding notifying other users about the shared battery power information, then the battery power-based configuration module 420 may cause the user interface module 352 to display information regarding the received battery power information of the particular device.

In some embodiments, after the battery power-based configuration module 420 receives the prompt identifying the remote device and the low battery power level of the remote device, the battery power-based configuration module 420 modifies network encoding parameters to reduce a resolution and/or frame rate of media streams that are being shared between the various devices during the call. In some embodiments, after the battery power-based configuration module 420 receives the prompt identifying the remote device and the low battery power level of the remote device, the battery power-based configuration module 420 selectively modifies the network encoding parameters to generate lower resolution and/or lower frame rate media streams only for the media streams shared with the affected remote device, while maintaining the higher resolution encoding and/or higher frame rate media streams for the other remote participants in the call.

In some embodiments, after the battery power-based configuration module 420 receives the prompt identifying the remote device and the low battery power level of the remote device, the battery power-based configuration module 420 obtains, from the storage medium 350, a list of all the applications being executed during the call (e.g., AR/VR effects, games, story-time applications, video sharing, music sharing, karaoke, etc.). Subsequently, the battery power-based configuration module 420 may trigger a switchover to a lightweight power version of the applications when available. In some embodiments, the switchover to lightweight power versions of the applications is performed only with respect to the in-call link between the communication system 320 and the identified remote device with the low battery power. In some embodiments, the switchover to lightweight power versions of the applications is performed for all the remote devices in call with the communication system 320, leading to all the users in the call having a consistent in-call sharing experience with similar media resolutions, frame rates, and available features. In some embodiments, after the battery power-based configuration module 420 receives the prompt identifying the remote device and the low battery power level of the remote device, the battery power-based configuration module 420 triggers a switchover to an alternate application with lesser battery power requirements. Thus, in some embodiments, the battery power-based configuration module 420 causes the in-call experience between communication system 320 and the identified remote device to switchover from a video call to an audio-only call. In some embodiments, such switchovers occur across all of the in-call remote devices.

### Repair-Enabled Battery Containment Structure

Some embodiments of the present disclosure are directed to a battery containment structure for containing a battery (e.g., the battery 125). The battery containment structure presented herein is repair enabled, i.e., the battery containment structure allows for easy access to and replacement of a battery. A portion of the battery containment structure that receives a battery may be referred to as a nest. Designing a nest to contain a battery (e.g., lithium battery) in consumer electronic devices (e.g., headsets) is typically challenging. Design requirements for the nest may include: (i) forming a Faraday Cage to avoid interference with antennas; (ii) ensuring that safety of a battery is met by avoiding any sharp corners (or any other parts) facing the battery that may potentially puncture the battery during assembly; (iii) allowing safe repair of a consumer electronic device without damaging a battery; (iv) ensuring that a battery survives reliability tests (e.g., drop, vibration, temperature cycle, etc.); and (v) having a gap on one flat face of a battery for the battery to swell and to have equal gaps among four sides for the battery due to manufacturing and part tolerances and some slight swelling.

FIG. 5A illustrates an example side view of a battery containment structure 500, in accordance with one or more embodiments. The battery containment structure 500 includes a metal chassis 505 (i.e., nest). The metal chassis 505 is a portion of the battery containment structure 500 configured to receive a battery (not shown in FIG. 5A). The metal chassis 505 includes five surfaces (e.g., a floor and four vertical walls). Inner surface of the floor and the walls of the metal chassis 505 may be coated with an electrical insulator to be electrically insulative for safety of the battery. At least portions of the battery containment structure 500 outside metal chassis 505 may be made of plastic.

FIG. 5B illustrates an example top view of the battery containment structure 500, in accordance with one or more embodiments. As shown in FIG. 5B, the battery containment structure 500 may be at least partially surrounded by one or more antennas 510 (e.g., part of a transceiver of the headset 100 or the headset 105). The metal chassis 505 may not be extendable beyond edges 515 due to other sub-assemblies of the battery containment structure 500. Furthermore, the metal chassis 505 may not be extendable beyond walls 520A, 520B due to interference with the one or more antennas 510. Also, the metal chassis 505 may not be extendable beyond corners 525 due to interference with the one or more antennas 510.

FIG. 5C illustrates an example battery pack 530 with a lid 535 for placement into the metal chassis 505 of the battery containment structure 500, in accordance with one or more embodiments. The battery pack 530 is a package that includes a battery (e.g., rechargeable lithium battery). The battery pack 530 may be configured such that the battery of the battery pack 530 can adhere to the lid 535. Dimensions of the battery and the battery pack 530 may be set based on dimensions of the metal chassis 505.

The battery pack 530 may be bonded to the lid 535 via one or more pressure sensitive adhesive (PSA) structures 540. A PSA structure 540 may be implemented as a stretch-release PSA to adhere the battery pack 530 to a structural part of the battery containment structure 500 (i.e., the metal chassis 505). In one or more embodiments, the stretch-release PSA can be applied between the battery pack 530 and the metal chassis 505. When repair of the battery containment structure 500 is necessary, the stretch-release PSA can be pulled where it is stretched and released between the battery pack 530 and a structural substrate of the battery containment structure 500. The battery pack 530 may be discarded (e.g., with property battery disposal protocol) once the battery pack 530 is removed from the battery containment structure 500 during repair, whether or not the battery is damaged or the battery pack 530 is untouched.

The battery pack 530 may be located centrally within the four vertical walls of the metal chassis 505 to achieve as equal gaps as possible relative to the four vertical walls, e.g., for equal expansion of the battery pack 530 and manufacturing tolerances. The advantage of the structure shown in FIG. 5C is that it is easier to align the battery pack 530 (i.e., the battery) into the metal chassis 505 as all gaps to the vertical walls of the metal chassis 505 are visible. The battery pack 530 can be centrally-aligned visually with the four vertical walls of the metal chassis 505. The alignment of the battery pack 530 can be performed using, e.g., mechanical fixtures or machine vision equipment.

The lid 535 is a sheet metal configured to couple to the metal chassis 505. The lid 535 may be coupled to the battery pack 530 (e.g., via the one or more PSA structures 540) to form a battery assembly. The battery assembly (e.g., the battery pack 530 bonded to the lid 535) when coupled to the metal chassis 505 forms (with other sub-assemblies) the battery containment structure 500. In one or more embodiments, the lid 535 is configured as a sheet metal cage around the battery pack 530. In one or more other embodiments, the lid 535 is implemented as sheet metal tabs that can be screwed into a structural part of the battery pack 530.

It should be noted that vertical walls of the metal chassis 505 cannot be extendable over corner edges 545 due to other sub-assemblies or interference with antennas (e.g., the one or more antennas 510 in FIG. 5B). However, middle sections of the vertical walls of the metal chassis 505 can be extended farther from the battery pack 530. This can allow that one or more flanges are added to the lid 535 for alignment (e.g., the one or more flanges 550 shown in FIG. 5D).

In some embodiments, the battery pack 530 can first adhere to the lid 535 prior to lowering the battery pack 530 into the metal chassis 505. The alignment of the battery pack 530 to the four vertical walls of the metal chassis 505 can be one challenge. Another challenge can be a structural support of the battery pack 530 since the battery pack 530 is not adhered to a solid metal structure but to a flexible piece of a sheet metal of the lid 535. The metal chassis 505 and the sheet metal of the lid 535 can be configured to address these challenges. An advantage of the design presented in FIG. 5C is the ease of removing the battery pack 530. The lid 535 may include extended tabs where there are screws to hold the lid 535 and the battery pack 530 to the metal chassis 505. The battery pack 530 may be attached to the lid 535, e.g., to access and remove the battery pack 530, thus improving the safety factor of the overall design of the battery containment structure 500.

FIG. 5D illustrates a more detailed view of the battery pack 530 with the lid 535, in accordance with one or more embodiments. The one or more flanges 550 may be used to align the battery pack 530 with the lid 535 (and the metal chassis 505) along the y axis. The one or more flanges 550 may be positioned inside the metal chassis 505. It may not be possible to include additional flanges for alignment of the battery pack 530 with the lid 535 along the x axis as one of the goals is to increase a volume of the battery pack 530. A fixture (not shown in FIG. 5D) may be used to center the battery pack 530 to the lid 535 along the x axis. One or more conductive PSA structures 555 may be placed onto the lid 535 to form a Faraday Cage with the metal chassis 505 around the battery pack 530.

In some embodiments, due to space limitation and to have as large as possible a battery volume, the battery pack 530 can be implemented as a soft battery pack without a separate lid 535. In such cases, the lid 535 (i.e., sheet metal cage) may be an integral part of the battery pack 530. In some other embodiments, the metal chassis 505 is configured as a battery nest with five sides, i.e., four vertical walls and a ceiling. In such cases, the battery pack 530 may fit into the battery nest (i.e., metal chassis 505) and may be closed from an upper side with a piece of sheet metal.

FIG. 5E illustrates a detailed top view of the lid 535, in accordance with one or more embodiments. The one or more flanges 550 of the lid 535 may be positioned inside the four vertical walls of the metal chasses 505. The lid 535 may further include one or more holes 560, e.g., for inspection and to ensure sufficient gaps between the metal chassis 505 and the battery pack 530.

There are several main advantages of the battery containment structure 500 shown in FIGS. 5A-5E. First, the battery pack 530 can be removed with no risk of damaging. Second, there is no loss of battery volume in comparison with the conventional assembly. Third, there is no loss in centering accuracy between the battery pack 530 and the four vertical walls of the metal chassis 505. Fourth, sufficient gaps are ensured between the metal chassis 505 and the battery pack 530 by utilizing the one or more holes 560.

### Solar Heat Reflective and Device Radiative Aesthetic Coating

Some embodiments of the present disclosure relate to a coating of a headset, e.g., the headset 100. The coating presented herein have its emissivity (or reflectivity) tuned over the electromagnetic spectrum to achieve multiple objectives. First, the coating presented herein minimizes emissivity in the ultraviolet (UV) to near-infrared (NIR) spectrum (e.g., between 0.2 μm and 3.0 μm) to minimize absorption of solar energy that yields undesirable heating of a surface of the headset. Second, the coating presented herein maximizes the emissivity in the mid-far infrared spectrum (e.g., between 3.0 μm and 30.0 μm) to enable re-radiation from the surface of the headset to the deep space through the atmospheric transmission window, reducing the temperature of the surface of the headset. Lastly, the emissivity profile of the coating presented herein may be tuned to provide a target aesthetic color (e.g., blue, green, black, etc.). The target aesthetic color may be achieved via an addition of spectral notching in the visible spectrum (e.g., between 0.3 μm and 0.8 μm). Note that traditional approaches at designing solar reflective coatings have neglected to include a requirement for aesthetic. The coating presented herein represents a balance of aesthetic and thermal requirements as these requirements compete in the visible spectrum. The coating presented herein may be formed using, e.g., optical layered stacks, films, paints, some other methodology described herein, or some combination thereof.

FIG. 6A illustrates an example graph 600 of spectral emissivity for black coating, in accordance with one or more embodiments. FIG. 6B illustrates an example graph 610 of spectral emissivity for green coating, in accordance with one or more embodiments. Although the spectral emissivity only for black and green coatings are shown in FIGS. 6A-6B, the technique presented herein holds for any desired coating color/aesthetic. It can be observed from FIGS. 6A-6B that, for the typical solar flux and idealized black and green coatings, the re-radiation in space within the mid-far infrared spectrum (e.g., between 3.0 μm and 30.0 μm) can be substantial, thus reducing a temperature of a surface exposed to the solar flux. The impact of the aesthetic solar coating presented herein has a substantial impact on reduction of a temperature of a surface when the surface is exposed to the solar flux. The temperature reduction of the surface may directly translate to additional capabilities in consumer and mobile devices (e.g., wearable devices or headsets) in outdoor environments, improving the user experience for such devices.

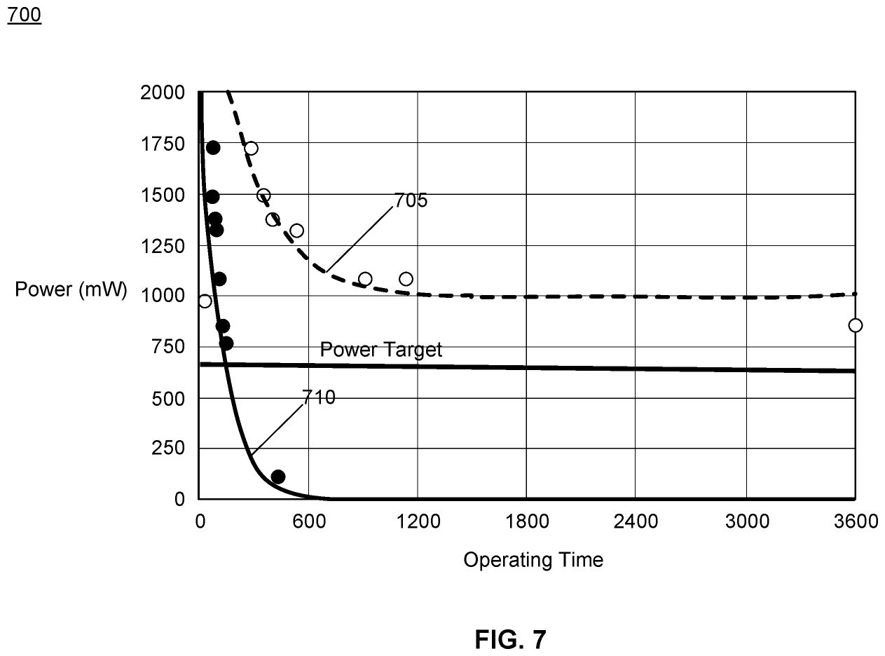

FIG. 7 illustrates an example graph 700 of “allowable power” for a headset with a black off-the-shelf coating and a headset with an aesthetic black coating, in accordance with one or more embodiments. The “allowable power” can be synonymous with allowing a specific user experience, e.g., watching a video or playing a game on a mobile phone. The aesthetic solar coating can take the headset from negligible outdoor capability into enabling the headset to provide additional experiences to the user. Even in the case of an “unpowered” product that provides no discrete user experience, the approach can be used to improve thermal safety in outdoor solar environments. As shown by a plot 705 in FIG. 7 representing the “allowable power” as a function of operating time for the aesthetic black coating, the aesthetic black coating enables outdoor use cases while providing the “allowable power” greater than a power target. Note that a limit for a surface temperature may set to a defined temperature of, e.g., 43° C. On the other hand, as shown by a plot 710 in FIG. 7 representing the “allowable power” as a function of operating time for the off-the-shelf black coating, the off-the-shelf black coating provides negligible outdoor capability.

The coating presented herein represents a solar reflecting coating that achieves a specific aesthetic target. Further, the coating presented herein is mechanically robust and suitable for application at high volume. The coating may be formed from one or more heat reflective paints. Paint is one of the easiest and scalable solutions to achieve target colors in products. In one or more embodiments, special pigments can be utilized in the paint to selectively absorb the light photons in the visible spectrum. For example, the color black is achieved by absorbing all photons in visible spectrum. In contrast, commercial off-the-shelf paint and resins have carbon black absorbing wavelengths from UV to mid-IR. If the pigments in the paint are made to be transmitting in the IR spectrum, then an intermediate coat can be leveraged to scatter/reflect the IR light. For example, in some embodiments, the pigments may be TiO₂ particles, and sizing of the particles is chosen to obtain a specific color/emissivity (e.g., to reflect blue light which is of high energy). The coating presented herein may comprise a top-coat that is dark, an intermediate coat that is light scattering (e.g., white or silver), and a bottom coat (e.g., a primer). Additionally, in some embodiments, the coating may also reflect the UV component of the solar spectrum.

The coating may be formed from layered surface treatments. Like anti-reflective coating, in some embodiments, a multi-layered thin film coating may be used for the coating to selectively reflect specific wavelengths of light. In some other embodiments, a multi-layered polymer film with alternatively varying refractive index is used for the coating to selectively reflect wavelengths of light. In some embodiments, the coating includes Germanium. The Germanium may be a thin film deposited by, e.g., a plasma vapor deposition process.

In some embodiments, a coating of a device (e.g., headset) is presented, wherein the device in an active state is configured to generate heat. The coating may be configured to: (i) have emissivity of a first average value over an UV band of radiation and a NIR band of radiation; (ii) have an emissivity of a second average value over a visible band of radiation; and (iii) have emissivity of a third average value for a band of radiation in the mid-to-far infrared. The first average value may be less than the second average value, and the second average value may be less than the third average value. Alternatively, the second average value may be the same as the third average value. Incident radiation in the UV and the NIR may be substantially reflected by the presented coating. Incident radiation in the visible band may be such that the coating appears a target color, and the generated heat in the mid-to-far infrared may be substantially absorbed and re-radiated.

The frame 110 of the headset 100 may be coated with a solar heat reflective and device radiative aesthetic coating as described above. The coating of the frame 110 may have an emissivity of a first average value over an UV band of radiation and a NIR band of radiation that is low (e.g., close to zero). The coating of the frame 110 may also have an emissivity of a second average value over a visible band of radiation. The emissivity over the visible band of radiation may be such that the coating appears as a particular (target) color. The coating of the frame 110 may have an emissivity of a third average value for a band of radiation in the mid-to-far infrared. The emissivity over the band of radiation in the mid-to-far infrared may be relatively high (e.g., close to 1). The first average value may be less than the second average value, and the second average value may be less than the third average value. In this manner, incident radiation in the UV and the NIR bands may be substantially reflected by the coating. Incident radiation in the visible band may be such that the coating of the frame 110 appears having a target color. Heat generated in the mid-to-far infrared by active components (e.g., DCA, display elements, audio system, etc.) of the headset 100 may be substantially absorbed and re-radiated away from the headset 100.

### Solar Heat Reflective and Device Radiative Aesthetic Layered Coating

Some embodiments of the present disclosure relate to a coating of a device (e.g., headset) that presents as a particular color, and has increased reflective cooling for solar flux (e.g., UV into NIR), while having high emissivity in the mid-far infrared (e.g., heat emitted by the device). In some embodiments, a substrate (e.g., frame of the device) is coated via plasma vapor deposition (PVD) and/or chemical vapor deposition (CVD) with one or more thin films that are reflective to solar flux and have high emissivity for lower wavelengths. A second ‘color’ coating (e.g., paint) may be applied over the one or more thin films to create an aggregate coating. The second coating may be configured to absorb and/or scatter (e.g., via embedding particles) light in certain bands while being transparent to light outside those bands. In other embodiments, the substrate is composed of ultra-high molecular weight polyethylene (UHMWPE) (e.g., for solar reflectivity), and is then coated with an UV/IR transparent tint coating (e.g., for aesthetics) to form the aggregate coating.

The aggregate coating presented herein may be configured such that its emissivity (or reflectivity) is tuned over the electromagnetic spectrum to achieve multiple objectives. First, aggregate coating presented herein may reduce emissivity in the UV to NIR spectrum (e.g., between 0.2 μm and 3.0 μm) to reduce absorption of solar energy that yields undesirable heating of a surface. Second, the aggregate coating presented herein may increase the emissivity in the mid-to-far infrared spectrum (e.g., between 3.0 μm and 30.0 μm) to enable re-radiation from the surface to deep space through the atmospheric transmission window, thus reducing a temperature of the surface. Lastly, the emissivity profile of aggregate coating presented herein may be tuned to provide a target aesthetic color (e.g., blue, green, black, etc.). The target color may be achieved via an addition of spectral notching in the visible spectrum (e.g., between 0.3 μm and 0.8 μm).

The aggregate coating presented herein represents a tradeoff between aesthetic and thermal requirements (competitive requirements in the visible spectrum), and robustness. The aggregate coating presented herein represents a solar reflecting coating that achieves a specific aesthetic target. Furthermore, the aggregate coating presented herein is mechanically robust and suitable for application at high volume. Note that the techniques presented herein are combined into producing a multi-purpose coating structure to address solar heating, radiative cooling, and product appearance.

The aggregate coating presented herein may be formed from one or more heat reflective paints. Paint is one of the easiest and scalable solutions to achieve target colors in products. Special pigments may be utilized in the paint to selectively absorb the light photons in the visible spectrum. To be more specific, the color black can be achieved by absorbing all photons in visible spectrum. In contrast, commercial off-the-shelf paint and resins have carbon black that absorbs wavelengths from UV to mid-IR. If the pigments in the paint are made to be transmitting in the IR spectrum, an intermediate coat may be leveraged to scatter/reflect the IR light. For example, in some embodiments, the pigments may be TiO₂ particles, and the sizing of the particles may be chosen to obtain a specific color/emissivity (e.g., reflect blue light which is of high energy).

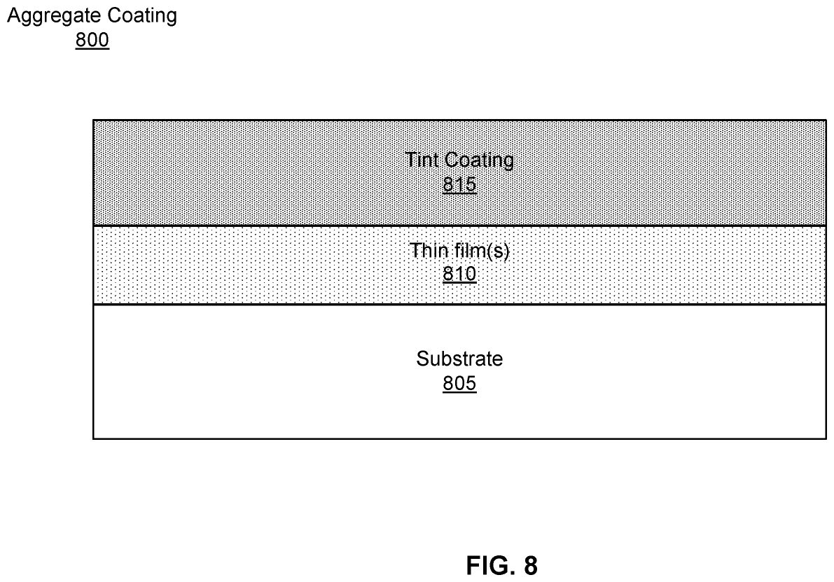

FIG. 8 illustrates an example aggregate coating 800, in accordance with one or more embodiments. The aggregate coating 800 may comprise a substrate 805, one or more films 810, and a tint coating 815. The substrate 805 may be, e.g., plastic, metal, UHMWPE, some other suitable material, or some combination thereof. One potential advantage of UHMWPE is that in addition to having good mechanical and thermal properties, UHMWPE can be tuned to have a very high solar reflectance. The substrate 805 may be part of a device (e.g., the frame 110 of the headset 100).

The one or more thin films 810 may be applied to the substrate 805. The one or more thin films 810 may be applied via, e.g., PVD and/or CVD. The one or more thin films 810 may be, e.g., oxide, Germanium, Indium, Silicon, Tin, etc. The one or more thin films 810 may have a total thickness of 5 μm or less. For example, the one or more thin films 810 may have a total depth of 2 μm. The one or more thin films 810 may be configured to mitigate emissivity in the UV to NIR spectrum, and to increase the emissivity in the mid-to-far infrared. In some embodiments, the one or more thin films 810 may be selected to help facilitate tuning the emissivity profile of the aggregate coating 800 to provide a target aesthetic color (e.g., blue, green, black, etc.).

The tint coating 815 may be applied over the one or more thin films 810 to form the aggregate coating 800. The tint coating 815 may be a cosmetic purpose color coating (e.g., spay, dip, flow, etc.) The tint coating 815 may be substantially thicker than the one or more thin films 810. For example, the tint coating 815 may be approximately 20 μm thick, and the one or more thin films 810 may be, e.g., 2 μm thick. The tint coating 815 may be configured to absorb and/or scatter (e.g., via embedding particles) light in certain visible bands (e.g., to establish a color the coated substrate presents as) while being transparent to light outside those bands. In this manner, the aggregate coating 800 may have an emissivity distribution in the UV and NIR bands that is lower than an emissivity distribution in the visible band, and the emissivity distribution in the visible band may be lower than an emissivity distribution in the mid-to-far IR band. Note that this may depend on some degree on a target aesthetic color. For example, if the target aesthetic color is a dark black, it may be possible for the emissivity in the visible band to be similar, or even higher, than the emissivity in the mid-to-far IR band.

In some embodiments (not shown in FIG. 8), an additional UV/IR transparent tint coating is applied over the tint coating 815 to further enhance aesthetic appearance of the aggregate coating 800. In some embodiments, the substrate 805 is composed of UHMWPE, and an UV/IR transparent tint coating (not shown in FIG. 8) is applied directly to the UHMWPE to form the aggregate coating 800. In this embodiment, the UHMWPE provides the functionality (e.g., solar reflectivity) of the one or more thin films 810, and the UV/IR transparent tint coating provides the functionality (e.g., color) of the tint coating 815. In some embodiments, the UHMWPE can be a single film with the thickness greater than 5 μm (e.g., 10 μm, 25 μm, 50 μm, etc.). Alternatively, the UHMWPE may be a stack of compressed UHMWPE films with a total thickness greater than 500 μm (e.g., 1 mm, 5 mm, 10 mm, etc.). In some embodiments, the UHMWPE can be laminated on polyvinylidene fluoride (PVDF) or polyvinyl chloride (PVC) to increase the emissivity in the long wavelength infrared (e.g., between 8 μm and 14 μm) and hence re-radiation to space. PVDF or PVC can be in the form of film, porous film, fiber-film, some other type of film, or combination thereof.

In some embodiments a method for coating a device (e.g., the headset 100) is presented herein. One or more thin films (e.g., the one or more thin films 810) may be applied to a first surface of the device (e.g., the substrate 805 or the frame 110 of the headset 100). A paint coating (e.g., the tint coating 815) may be then applied to a surface of the one or more thin films to form an aggregate coating (e.g., the aggregate coating 800). The aggregate coating may be an emissivity distribution that includes an UV band, a NIR band, a visible band, and a mid-to-far IR band. The emissivity distribution in the UV and NIR bands may be lower than the emissivity distribution in the visible band, and the emissivity distribution in the visible band may be lower than the emissivity distribution in the mid-to-far IR band. The aggregate coating may present as a target color, and heat generated by the device in the mid-to-far IR band may be substantially absorbed and re-radiated.

The frame 110 of the headset 100 may be coated with the aggregate coating 800 that represents a solar heat reflective and device radiative aesthetic coating. The aggregate coating 800 of the frame 110 may have an emissivity of a first average value over an UV band of radiation and a NIR band of radiation that is low (e.g., close to zero). The aggregate coating 800 of the frame 110 may also have an emissivity of a second average value over a visible band of radiation. The emissivity over the visible band of radiation may be such that aggregate coating 800 appears as a particular (target) color. The aggregate coating 800 of the frame 110 may have an emissivity of a third average value for a band of radiation in the mid-to-far infrared. The emissivity over the band of radiation in the mid-to-far infrared may be relatively high (e.g., close to 1). The first average value may be less than the second average value, and the second average value may be less than the third average value. In this manner, incident radiation in the UV and the NIR bands may be substantially reflected by the aggregate coating 800. Incident radiation in the visible band may be such that the aggregate coating 800 of the frame 110 appears having a target color. Heat generated in the mid-to-far infrared by active components (e.g., DCA, display elements, audio system, etc.) of the headset 100 may be substantially absorbed and re-radiated away from the headset 100.

### HDMI Derived Network Timing for Distributed Audio-Video Synchronization

Some embodiments of the present disclosure are related to distributed Audio-Video (AV) conferencing systems in a local area (e.g., large meeting room spaces). When considering audio capture during a typical video conference, a distance between an active speaker and an audio capture device (e.g., microphone on a headset) directly affects the audio quality. This is due to the relationship between the room reverberation environment and the direct sound path (e.g., a distance between the audio capture device and the active speaker), combined with the signal-to-noise/sensitivity characteristics of the audio capture device.

In a large video conferencing environment with multiple active speakers, several microphones (i.e., audio capture devices) are typically required to minimize the direct sound path distance for all participants. This may be achieved with direct wiring from a microphone to a main processing device but requires a dedicated wiring for each microphone. Increasing the number of microphones increases the installation effort, cost, and complexity. This complexity becomes increasingly significant when incorporating multiple sensors for applications such as microphone-array beamforming.

A target solution presented herein is a scalable, distributed audio system that allows connection of multiple audio capture devices (e.g., microphones). The audio capture device may be a single microphone, multiple microphones, an autonomous beamforming device, or some other device capable of detecting audio. The preferred connection method from an array of audio capture devices to a main processing unit is a standard network interface (e.g., Ethernet), which offers minimal installation complexity and is typically available in an enterprise environment. However, the use of distributed audio capture devices in this scenario creates a challenge with time synchronization. Typically, each audio capture device would generate its own audio sampling clock from a local oscillator circuit, leading to arbitrary time and frequency offsets. This creates problems for audio video synchronization, synchronization between each audio capture device, and particularly for Acoustic Echo Cancellation (AEC) that uses a synchronous relationship between capture and render sample clocks.

FIG. 9 illustrates an example graph 900 for an AEC performance degradation caused by a sample clock offset, in accordance with one or more embodiments. The graph 900 shows the AEC performance represented by an Echo Return Loss Enhancement (ERLE) as a render clock offset relative to a capture clock is increased. It can be observed from the graph 900 that offsets of more than a few parts per million (ppm) can lead to substantial ERLE performance degradation. It is however well known that the typical variation due to crystal oscillator tolerances can lead to frequency offsets of tens of ppm.

FIG. 10A illustrates an example audio system 1000 with a distributed clocking scenario, in accordance with one or more embodiments. The audio system 1000 may include an AV render device 1002, a primary device 1004, an Ethernet switch 1006, and audio capture devices 1008, 1010. The audio system 1000 may be an embodiment of the audio system 200. The AV render device 1002 may present an audio/video to a user. The AV render device 1002 may be, e.g., a television set with one or more speakers. The AV render device 1002 may be coupled to the primary device 1004 via a HDMI connection 1012.

The primary device 1004 may be a device capable of an audio and video capture. The primary device 1004 may be implemented as a video conferencing endpoint device. Both the audio and video capture at the primary device 1004 may be synchronized to a first clock of a first crystal oscillator, XTAL1. Thus, an AEC instance for the audio capture of the primary device 1004 would operate correctly. One or more sample clocks of the AV render device 1002 may be synchronized to the first clock, XTAL1, e.g., via the HDMI connection 1012.

The Ethernet switch 1006 may be a switching device configured to connect or disconnect the one or more audio capture devices 1008, 1010 with the primary device 1004. The Ethernet switch 1006 may be connected to the primary device 1004 via an Ethernet connection 1014. Further, the Ethernet switch 1006 may be connected to the audio capture devices 1008, 1010 via an Ethernet connection 1016 and an Ethernet connection 1018, respectively.

The audio capture devices 1008, 1010 may be devices capable of capturing audio within a local area. Each of the audio capture devices 1008, 1010 may be, e.g., a single microphone, multiple microphones, an autonomous beamforming device, or some other device capable of detecting audio. The audio capture devices 1008, 1010 may represent secondary audio capture devices of the system 1000, whereas the primary device 1004 is a primary audio capture device. Each audio capture device 1008, 1010 may use its locally generated sample clocks, e.g., a second clock of a second local oscillator, XTAL2, and a third clock of a third local oscillator, XTAL3. Each audio capture device 1008, 1010 may include an AEC instance that uses a copy of the rendered audio from the primary device 1004 as a cancellation reference. Therefore, each audio capture device 1008, 1010 would have an associated capture/render sample clock offset, e.g., an offset of XTAL2 relative to XTAL1 and an offset of XTAL3 relative to XTAL1.

One approach for synchronizing local clocks of the audio capture devices 1008, 1010 with a clock of the primary device 1004 involves usage of a network timing (e.g., IEEE1588 precision time protocol (PTP) based network timing) to accurately distribute time across the Ethernet network of the system 1000. In this approach, one or more hardware based timestamped messages may be exchanged between the primary device 1004 (i.e., master node) and the audio capture devices 1008, 1010 (i.e., slave nodes) to align clocks in this master/slave topology. Extremely accurate clock alignment between the master and slave nodes can be achieved, e.g., a clock offset of less than 1 ppm. Using a PTP derived clock as a reference (derived at the primary device 1004), an accurate sample clock may be generated at the audio capture devices 1008, 1010 (or used at the audio capture devices 1008, 1010 to perform sample rate correction) to match the master node clock (i.e., the first clock XTAL1 of the primary device 1004).

FIG. 10B illustrates an example master-slave arrangement for an audio system 1020 using the PTP for clock synchronization, in accordance with one or more embodiments. The audio system 1020 may include a PTP master node 1022 and a PTP slave node 1036 that mutually exchange an Ethernet traffic 1036. The PTP master node 1022 may be an embodiment of the primary device 1004, and the PTP slave node 1036 may be an embodiment of the audio capture device 1008 or the audio capture device 1010. The PTP master node 1022 may include an audio capture analog-to-digital converter (ADC) 1024, a master central processing unit (CPU) 1028, and an Ethernet adapter 1032. The PTP slave node 1036 may include an audio capture digital-to-audio converter (DAC) 1038, a slave CPU 1042, and an Ethernet adapter 1046. The audio system 1020 may be an embodiment of the audio system 200.

The audio capture ADC 1024 may convert a captured audio from an analog domain to a digital domain. The audio capture ADC 1024 may be part of a microphone. The audio capture ADC 1024 may have a local crystal oscillator clock XTAL-ADC. The audio capture ADC 1024 may provide the captured digital audio to the master CPU 1028 via a universal serial bus (USB) 1026. The master CPU 1028 may process the captured digital audio obtained from the audio capture ADC 1024. The master CPU 1028 may use a system clock, e.g., provided by a crystal oscillator XTAL-CPU-MASTER. The master CPU 1028 may provide the processed digital audio to the Ethernet adapter 1032 via a connection 1030 (e.g., 1PPS GP10 protocol connection). The Ethernet adapter 1032 may adapt the processed digital audio obtained from the master CPU 1028, e.g., for sending the adapted digital audio as part of the Ethernet traffic 1034 to the PTP slave node 1036. The Ethernet adapter 1032 may use a PTP hardware clock, e.g., provided by a crystal oscillator XTAL-ETH-MASTER.

The Ethernet adapter 1046 of the PTP slave node 1036 may receive the captured digital audio from the PTP master node 1022 as part of the Ethernet traffic 1034. The Ethernet adapter 1046 may adapt the received digital audio, e.g., for usage by the slave CPU 1042. The Ethernet adapter 1046 may use a PTP hardware clock, e.g., provided by a crystal oscillator XTAL-ETH-SLAVE. The Ethernet adapter 1046 may provide the adapted digital audio to the slave CPU 1042 via a connection 1044 (e.g., 1PPS GP10 protocol connection). The slave CPU 1042 may process the adapted digital audio received from the Ethernet adapter 1046. The slave CPU 1042 may use a system clock, e.g., provided by a crystal oscillator XTAL-CPU-SLAVE. The slave CPU 1042 may provide the processed digital audio to the audio capture DAC 1038 via a USB 1040. The audio capture DAC 1038 may convert the processed digital audio received from the slave CPU 1042 from a digital domain to an analog domain, e.g., for presentation to a user via one or more speakers. The audio capture DAC 1038 may be part of the one or more speakers. The audio capture DAC 1038 may use a local clock, e.g., provided by a crystal oscillator XTAL-DAC.

The process of aligning sample clocks of the PTP master node 1022 and the PTP slave node 1036 may be as follows. First, digital audio capture stream provided by the audio capture ADC 1024 may be time-stamped using the system clock of the master CPU 1028. Second, the PTP hardware clock of the Ethernet adapter 1032 may be synchronized to the system clock of the master CPU 1028. Third, the PTP hardware clock of the Ethernet adapter 1046 may be synchronized to the PTP hardware clock of the Ethernet adapter 1032. Fourth, the system clock of the slave CPU 1042 may be synchronized to the PTP hardware clock of the Ethernet adapter 1046. Fifth, the audio capture DAC 1038 may resample audio render stream obtained from the slave CPU 1042 (i.e., sample-rate correction is performed at the audio capture DAC 1038) to match the system clock of the slave CPU 1042.

The PTP based audio system 1020 shown in FIG. 10B is configured to accurately align the PTP hardware clocks of the Ethernet adapters 1032 and 1046. After that, timers of the system clocks of the master CPU 1028 and the slave CPU 1042 may be aligned to the PTP hardware clocks. This alignment may be performed by, e.g., servo control loops with an accurate hardware timing signal, such as, one pulse per second (1PPS). Once the system clocks of the master CPU 1028 and the slave CPU 1042 are aligned, the audio stream at the PTP slave node 1036 can be resampled (e.g., based on time-stamps of the system clock of the slave CPU 1042) to match sampling of the audio stream at the PTP master node 1022 (i.e., at the audio capture ADC 1024).

It can be observed that there are six asynchronous clock domains involved in the generic setup shown of FIG. 10B. The more clock domains to be aligned, the lower the overall accuracy is as each correction step (e.g., servo loops, audio timestamping) potentially introduces alignment errors, increases complexity and the time taken to achieve end-to-end synchronization.

Embodiments described herein are further related to an approach to reduce a number of asynchronous clock relationships in the end-to-end system, by adding a network timing capable module as an accessory to a primary video conferencing (VC) endpoint device (i.e., master node). An accessory device (i.e., a dock device) would exploit the synchronous relationship between an AV output (i.e., HDMI) of the primary VC endpoint device to create a common clock domain for a PTP hardware clock and audio sample clocks.

FIG. 10C illustrates an example configuration of an audio system 1050 with an accessory device (i.e., dock device) operating as a master device for creating a common clock domain, in accordance with one or more embodiments. The audio system 1050 may include a PTP master node 1052, a dock device 1056 coupled to the PTP master node 1052, a PTP slave node 1064 coupled to the dock device 1056, and an AV render device 1066 coupled to the dock device 1056. The audio system 1050 may be an embodiment of the audio system 200.

The PTP master node 1052 may include a system-on-chip (SoC) 1054. The SoC 1052 may be coupled to one or more audio capture devices (e.g., one or more microphones) for capturing audio. The SOC 1054 may include the substantially same components as the PTP master node 1022 in FIG. 10B, i.e., the SOC 1054 may include an audio capture ADC, a master CPU, and an Ethernet adapter (not shown in FIG. 10C). The PTP master node 1052 may use a system clock provided by, e.g., a master oscillator. In an embodiment, the SoC 1054 may provide a digital audio stream to the dock device 1056 via, e.g., a USB. Furthermore, the system clock of the PTP master node 1052 may be provided to the dock device 1056 via, e.g., an HDMI interface.

The dock device 1056 may provide USB-Ethernet controller functionality (e.g., as a regular Ethernet adapter), while also providing an HDMI passthrough connection with the PTP master node 1052. The dock device 1056 may include, among other components, an USB hub 1058, a clock extraction circuit 1060, and an Ethernet adapter 1062. The USB hub 1058 may receive the audio stream from the SoC 1054 via the USB, provide the received audio stream further to the Ethernet adapter 1062. The clock extraction circuit 1060 may be coupled to the SoC 1054 via the HDMI passthrough connection (i.e., HDMI interface) to receive the system clock from the SoC 1054. The clock extraction circuit 1060 may extract the system clock from the HDMI interface and provide the extracted system clock to the Ethernet adapter 1062. The system clock extracted by the clock extraction circuit 1060 may be used as a timebase reference for a PTP hardware clock of the Ethernet adapter 1062. The usage of the HDMI extracted clock creates a common clock domain between the PTP master node 1052 (e.g., the primary VC endpoint device) and the dock device 1056.

The PTP slave node 1064 may represent a secondary audio capture device. The PTP slave node 1064 may have substantially the same components as the PTP slave node 1036 in FIG. 10B, i.e., the PTP slave node 1064 may include an audio capture DAC, a slave CPU and an Ethernet adapter (not shown in FIG. 10C). The PTP slave node 1064 may receive (e.g., via an Ethernet connection) a version of the audio stream adapted at the Ethernet adapter 1062 by utilizing the PTP hardware clock synchronized to the system clock of the PTP master node 1052. The AV render device 1066 may present an audio/video to a user. The AV render device 1066 may be, e.g., a television set with one or more speakers. The AV render device 1066 may be coupled to the dock device 1056 and the PTP master node 1052 via the HDMI interface. The AV render device 1066 may render the audio/video for presentation to the user by utilizing the system clock of the PTP master node 1052 extracted from the HDMI interface.

FIG. 10D illustrates an example configuration of an audio system 1070 with an accessory device (i.e., dock device) operating as a slave device for creating a common clock domain, in accordance with one or more embodiments. The audio system 1070 may include an audio capture device 1072, a dock device 1076 coupled to the audio capture device 1072, and a PTP master node 1084 coupled to the dock device 1076. The audio system 1070 may be an embodiment of the audio system 200.

The audio capture device 1072 may present a captured audio to a user. Alternatively, or additionally, the audio capture device 1072 may capture audio generated in a local area of the audio system 1070. The audio capture device 1072 may be a secondary audio capture device. The audio capture device 1072 may include a SoC 1074. The SoC 1074 may be coupled to one or more audio capture devices (e.g., one or more microphones) for presenting/capturing audio. The SOC 1074 may include the substantially same components as the PTP slave node 1036 in FIG. 10B, i.e., the SOC 1074 may include an audio capture DAC, a slave CPU, and an Ethernet adapter (not shown in FIG. 10D). The audio capture device 1072 may use a system clock provided by, e.g., a master oscillator. The SoC 1074 may communicate (transmit and/or receive) a digital audio stream with the dock device 1076 via, e.g., a USB. Furthermore, the system clock of the audio capture device 1072 may be provided to the dock device 1076 via, e.g., an HDMI interface.

The dock device 1076 may provide USB-Ethernet controller functionality (e.g., as a regular Ethernet adapter), while also providing an HDMI passthrough connection with the audio capture device 1072. The dock device 1076 may include, among other components, an USB hub 1078, a clock extraction circuit 1080, and an Ethernet adapter 1082. The USB hub 1058 may transmit/receive the audio stream to/from the SoC 1074 via the USB, and further communicate with the Ethernet adapter 1062. The clock extraction circuit 1080 may be coupled to the SoC 1074 via the HDMI passthrough connection (i.e., HDMI interface) to receive the system clock from the SoC 1074. The clock extraction circuit 1080 may extract the system clock from the HDMI interface and provide the extracted system clock to the Ethernet adapter 1082. The system clock extracted by the clock extraction circuit 1080 may be used as a timebase reference for a PTP hardware clock of the Ethernet adapter 1082. The usage of the HDMI extracted clock creates a common clock domain between the audio capture device 1072 (i.e., a PTP slave node) and the dock device 1076 and the PTP master node 1084.

The PTP master node 1084 may be a primary audio capture device (e.g., the primary VC endpoint device). The PTP master node 1064 may have substantially the same components as the PTP master node 1022 in FIG. 10B, i.e., the PTP master node 1064 may include an audio capture ADC, a master CPU, and an Ethernet adapter (not shown in FIG. 10D). The PTP master node 1084 may be a primary VC endpoint device. The PTP master node 1084 may provide (e.g., via an Ethernet connection) a digitized version of a captured audio stream to the Ethernet adapter 1082 of the dock device 1076. The PTP master node 1084 may perform resampling of the digitized captured audio stream using its system clock that is synchronized to the system clock of the audio capture device 1052, as well as to the PTP hardware clock of the dock device 1076.

One advantage of the approach for configuring audio systems shown in FIGS. 10C-10D is that there is only one critical asynchronous clock relationship in an audio system. Unlike the generic audio system configuration in FIG. 10B where cascaded servo loops are utilized to align CPU system clocks to PTP hardware clocks, the only critical time relationship is between the master and slave PTP hardware clocks. Another advantage of the approach shown in FIGS. 10C-10D is that once the PTP control loop is locked, the PTP master/slave clock offset directly provides the audio resampling correction factor. This is specifically because the PTP hardware clock (extracted/derived from the HDMI interface) is now synchronous to audio clocks. Another advantage of the approach shown in FIGS. 10C-10D is that there is no sensitivity to CPU/SoC system time for audio timestamping, or requirement for CPU system clock/PTP hardware clock alignment. Another advantage of the approach shown in FIGS. 10C-10D is faster overall synchronization time (e.g., only the PTP slave servo control loop is required to converge). Another advantage of the approach shown in FIGS. 10C-10D is addition of accurate hardware based timestamping to non-PTP capable VC endpoint as an accessory device (i.e., dock device).

In some embodiments, a method for clock synchronization in an audio system (e.g., the audio system 1050) is presented. A clock signal may be extracted using an HDMI connection between a video conferencing device (e.g., the PTP master node 1052) and a dock device (e.g., the dock device 1056). A common clock domain may be generated at the dock device using the extracted clock signal. The common clock may be used as a timebase for a PTP hardware clock (e.g., at the dock device 1056). A clock on an audio capture device (e.g., at the PTP slave node 1064) that is separate from the video conferencing device and the dock device may be synchronized using the PTP hardware clock.

### Process Flow

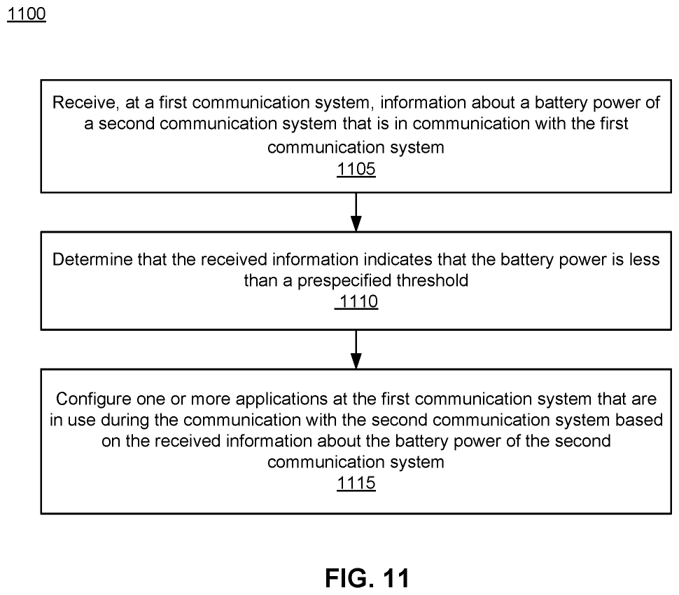

FIG. 11 is a flowchart illustrating a process 1100 for performing a battery power-based control of an in-call experience based on shared battery power information at a client device, in accordance with one or more embodiments. The process 1100 shown in FIG. 11 may be performed by a communication system (e.g., the communication system 320). Other entities may perform some or all of the steps in FIG. 11 in other embodiments (e.g., components of the audio system 1050). Embodiments may include different and/or additional steps, or perform the steps in different orders.

The communication system receives 1105 information about a battery power of a another communication system that is in communication with the communication system. The communication system may receive information about the battery power when a level of the battery power monitored at the other communication system is less than the prespecified threshold. The communication system may periodically receive the information about the battery power irrespective of a level of the battery power monitored at the other communication system.

The communication system determines 1110 that the received information indicates that the battery power is less than the prespecified threshold. The communication system configures 1115 one or more applications that are in use during the communication with the other communication system based on the received information about the battery power of the communication system. The one or more applications may comprise a plurality of communications between the communication system and a plurality of communication systems including the other communication system.

In some embodiments, the communication system (e.g., a video conferencing device) extracts a clock signal using a HDMI connection between the communication system and the other communication system (e.g., a dock device). The communication system may generate a PTP hardware clock using the extracted clock signal. The communication system may generate a common clock domain using the extracted clock signal. The communication system may generate the PTP hardware clock using the common clock domain as a timebase. The communication system may synchronize a clock on an apparatus (e.g., an audio capture device) that is separate from the communication system and the other communication system using the PTP hardware clock.

### System Environment

FIG. 12 is a system 1200 that includes a headset 1205, in accordance with one or more embodiments. In some embodiments, the headset 1205 may be the headset 100 of FIG. 1A or the headset 105 of FIG. 1B. The system 1200 may operate in an artificial reality environment (e.g., a virtual reality environment, an augmented reality environment, a mixed reality environment, or some combination thereof). The system 1200 shown by FIG. 12 includes the headset 1205, an input/output (I/O) interface 1210 that is coupled to a console 1215, the network 1220, and the mapping server 1225. While FIG. 12 shows an example system 1200 including one headset 1205 and one I/O interface 1210, in other embodiments any number of these components may be included in the system 1200. For example, there may be multiple headsets each having an associated I/O interface 1210, with each headset and I/O interface 1210 communicating with the console 1215. In alternative configurations, different and/or additional components may be included in the system 1200. Additionally, functionality described in conjunction with one or more of the components shown in FIG. 12 may be distributed among the components in a different manner than described in conjunction with FIG. 12 in some embodiments. For example, some or all of the functionality of the console 1215 may be provided by the headset 1205. A frame of the headset 1205 may be implemented as a solar heat reflective and device radiative aesthetic coating, e.g., as described above in conjunction with FIGS. 6A through 8.

The headset 1205 includes a display assembly 1230, an optics block 1235, one or more position sensors 1240, a DCA 1245, an audio system 1250, and a battery 1253. Some embodiments of headset 1205 have different components than those described in conjunction with FIG. 12. Additionally, the functionality provided by various components described in conjunction with FIG. 12 may be differently distributed among the components of the headset 1205 in other embodiments, or be captured in separate assemblies remote from the headset 1205.

The display assembly 1230 displays content to the user in accordance with data received from the console 1215. The display assembly 1230 displays the content using one or more display elements (e.g., the display elements 120). A display element may be, e.g., an electronic display. In various embodiments, the display assembly 1230 comprises a single display element or multiple display elements (e.g., a display for each eye of a user). Examples of an electronic display include: a liquid crystal display (LCD), an organic light emitting diode (OLED) display, an active-matrix organic light-emitting diode display (AMOLED), a waveguide display, some other display, or some combination thereof. Note in some embodiments, the display element 120 may also include some or all of the functionality of the optics block 1235.

The optics block 1235 may magnify image light received from the electronic display, corrects optical errors associated with the image light, and presents the corrected image light to one or both eye boxes of the headset 1205. In various embodiments, the optics block 1235 includes one or more optical elements. Example optical elements included in the optics block 1235 include: an aperture, a Fresnel lens, a convex lens, a concave lens, a filter, a reflecting surface, or any other suitable optical element that affects image light. Moreover, the optics block 1235 may include combinations of different optical elements. In some embodiments, one or more of the optical elements in the optics block 1235 may have one or more coatings, such as partially reflective or anti-reflective coatings.

Magnification and focusing of the image light by the optics block 1235 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block 1235 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 1235 corrects the distortion when it receives image light from the electronic display generated based on the content.

The position sensor 1240 is an electronic device that generates data indicating a position of the headset 1205. The position sensor 1240 generates one or more measurement signals in response to motion of the headset 1205. The position sensor 190 is an embodiment of the position sensor 1240. Examples of a position sensor 1240 include: one or more IMUs, one or more accelerometers, one or more gyroscopes, one or more magnetometers, another suitable type of sensor that detects motion, or some combination thereof. The position sensor 1240 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 1205 from the sampled data. For example, the IMU integrates the measurement signals received from the accelerometers over time to estimate a velocity vector and integrates the velocity vector over time to determine an estimated position of a reference point on the headset 1205. The reference point is a point that may be used to describe the position of the headset 1205. While the reference point may generally be defined as a point in space, however, in practice the reference point is defined as a point within the headset 1205.

The DCA 1245 generates depth information for a portion of the local area. The DCA includes one or more imaging devices and a DCA controller. The DCA 1245 may also include an illuminator. Operation and structure of the DCA 1245 is described above with regard to FIG. 1A.

The audio system 1250 provides audio content to a user of the headset 1205. The audio system 1250 is substantially the same as the audio system 200 described above. The audio system 1250 may comprise one or acoustic sensors, one or more transducers, and an audio controller. The audio system 1250 may provide spatialized audio content to the user. In some embodiments, the audio system 1250 may request acoustic parameters from the mapping server 1225 over the network 1220. The acoustic parameters describe one or more acoustic properties (e.g., room impulse response, a reverberation time, a reverberation level, etc.) of the local area. The audio system 1250 may provide information describing at least a portion of the local area from e.g., the DCA 1245 and/or location information for the headset 1205 from the position sensor 1240. The audio system 1250 may generate one or more sound filters using one or more of the acoustic parameters received from the mapping server 1225, and use the sound filters to provide audio content to the user.

In some embodiments, one or more components of the audio system 1250 perform (e.g., as described above in conjunction with FIG. 3 and FIG. 4) a battery power-based control of an in-call experience based on shared battery power information. In some other embodiments, one or more components of the audio system 1250 derives (e.g., as described below in conjunction with FIG. 9 and FIGS. 10A-10D) a network timing for distributed audio-video synchronization.

The battery 1253 may provide power to various components of the headset 1205. The battery 1253 may be a rechargeable battery. The battery 1253 may provide power to, e.g., the display assembly 1230, one or more components of the optics block 1235, the position sensor 1240, the DCA 1245, and/or one or more components of the audio system 1250. The battery 1253 may be an embodiment of the battery 125. The battery 1253 may be placed within a battery containment structure with a metal chassis having surfaces coated with electrical insulators, and a lid coupled to the metal chassis, e.g., as described above in conjunction with FIGS. 5A-5E.

The I/O interface 1210 is a device that allows a user to send action requests and receive responses from the console 1215. An action request is a request to perform a particular action. For example, an action request may be an instruction to start or end capture of image or video data, or an instruction to perform a particular action within an application. The I/O interface 1210 may include one or more input devices. Example input devices include: a keyboard, a mouse, a game controller, or any other suitable device for receiving action requests and communicating the action requests to the console 1215. An action request received by the I/O interface 1210 is communicated to the console 1215, which performs an action corresponding to the action request. In some embodiments, the I/O interface 1210 includes an IMU that captures calibration data indicating an estimated position of the I/O interface 1210 relative to an initial position of the I/O interface 1210. In some embodiments, the I/O interface 1210 may provide haptic feedback to the user in accordance with instructions received from the console 1215. For example, haptic feedback is provided when an action request is received, or the console 1215 communicates instructions to the I/O interface 1210 causing the I/O interface 1210 to generate haptic feedback when the console 1215 performs an action.

The console 1215 provides content to the headset 1205 for processing in accordance with information received from one or more of: the DCA 1245, the headset 1205, and the I/O interface 1210. In the example shown in FIG. 12, the console 1215 includes an application store 1255, a tracking module 1260, and an engine 1265. Some embodiments of the console 1215 have different modules or components than those described in conjunction with FIG. 12. Similarly, the functions further described below may be distributed among components of the console 1215 in a different manner than described in conjunction with FIG. 12. In some embodiments, the functionality discussed herein with respect to the console 1215 may be implemented in the headset 1205, or a remote system.

The application store 1255 stores one or more applications for execution by the console 1215. An application is a group of instructions, that when executed by a processor, generates content for presentation to the user. Content generated by an application may be in response to inputs received from the user via movement of the headset 1205 or the I/O interface 1210. Examples of applications include: gaming applications, conferencing applications, video playback applications, or other suitable applications.

The tracking module 1260 tracks movements of the headset 1205 or of the I/O interface 1210 using information from the DCA 1245, the one or more position sensors 1240, or some combination thereof. For example, the tracking module 1260 determines a position of a reference point of the headset 1205 in a mapping of a local area based on information from the headset 1205. The tracking module 1260 may also determine positions of an object or virtual object. Additionally, in some embodiments, the tracking module 1260 may use portions of data indicating a position of the headset 1205 from the position sensor 1240 as well as representations of the local area from the DCA 1245 to predict a future location of the headset 1205. The tracking module 1260 provides the estimated or predicted future position of the headset 1205 or the I/O interface 1210 to the engine 1265.

The engine 1265 executes applications and receives position information, acceleration information, velocity information, predicted future positions, or some combination thereof, of the headset 1205 from the tracking module 1260. Based on the received information, the engine 1265 determines content to provide to the headset 1205 for presentation to the user. For example, if the received information indicates that the user has looked to the left, the engine 1265 generates content for the headset 1205 that mirrors the user's movement in a virtual local area or in a local area augmenting the local area with additional content. Additionally, the engine 1265 performs an action within an application executing on the console 1215 in response to an action request received from the I/O interface 1210 and provides feedback to the user that the action was performed. The provided feedback may be visual or audible feedback via the headset 1205 or haptic feedback via the I/O interface 1210.

The network 1220 couples the headset 1205 and/or the console 1215 to the mapping server 1225. The network 1220 may include any combination of local area and/or wide area networks using both wireless and/or wired communication systems. For example, the network 1220 may include the Internet, as well as mobile telephone networks. In one embodiment, the network 1220 uses standard communications technologies and/or protocols. Hence, the network 1220 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 1220 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 1220 can be represented using technologies and/or formats including image data in binary form (e.g. Portable Network Graphics (PNG)), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

The mapping server 1225 may include a database that stores a virtual model describing a plurality of spaces, wherein one location in the virtual model corresponds to a current configuration of a local area of the headset 1205. The mapping server 1225 receives, from the headset 1205 via the network 1220, information describing at least a portion of the local area and/or location information for the local area. The user may adjust privacy settings to allow or prevent the headset 1205 from transmitting information to the mapping server 1225. The mapping server 1225 determines, based on the received information and/or location information, a location in the virtual model that is associated with the local area of the headset 1205. The mapping server 1225 determines (e.g., retrieves) one or more acoustic parameters associated with the local area, based in part on the determined location in the virtual model and any acoustic parameters associated with the determined location. The mapping server 1225 may transmit the location of the local area and any values of acoustic parameters associated with the local area to the headset 1205.

The HRTF optimization system 1270 for HRTF rendering may utilize neural networks to fit a large database of measured HRTFs obtained from a population of users with parametric filters. The filters are determined in such a way that the filter parameters vary smoothly across space and behave analogously across different users. The fitting method relies on a neural network encoder, a differentiable decoder that utilizes digital signal processing solutions, and performing an optimization of the weights of the neural network encoder using loss functions to generate one or more models of filter parameters that fit across the database of HRTFs. The HRTF optimization system 1270 may provide the filter parameter models periodically, or upon request to the audio system 1250 for use in generating spatialized audio content for presentation to a user of the headset 1205. In some embodiments, the provided filter parameter models are stored in the data store of the audio system 1250.

One or more components of system 1200 may contain a privacy module that stores one or more privacy settings for user data elements. The user data elements describe the user or the headset 1205. For example, the user data elements may describe a physical characteristic of the user, an action performed by the user, a location of the user of the headset 1205, a location of the headset 1205, HRTFs for the user, etc. Privacy settings (or “access settings”) for a user data element may be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 1200 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, at a first communication system, information about a battery power of a second communication system that is in communication with the first communication system;
determining that the received information indicates that the battery power is less than a prespecified threshold; and
configuring one or more applications at the first communication system that are in use during the communication with the second communication system based on the received information about the battery power of the second communication system.

2. The method of claim 1, further comprising:
receiving, at the first communication system, information about the battery power when a level of the battery power monitored at the second communication system is less than the prespecified threshold.

3. The method of claim 1, further comprising:
periodically receiving the information about the battery power at the first communication system irrespective of a level of the battery power monitored at the second communication system.

4. The method of claim 1, wherein the one or more applications comprise a plurality of communications between the first communication system and a plurality of communication systems including the second communication system.

5. The method of claim 1, further comprising:
extracting a clock signal using a high-definition multimedia interface (HDMI) connection between the first communication system and the second communication system;
generating a precision time protocol (PTP) hardware clock using the extracted clock signal; and
synchronizing a clock on an apparatus that is separate from the first communication system and the second communication system using the PTP hardware clock.

6. The method of claim 5, further comprising:
generating a common clock domain using the extracted clock signal; and
generating the PTP hardware clock using the common clock domain as a timebase.

7. The method of claim 5, wherein the first communication system comprises a video conferencing device, the second communication system comprises a dock device, and the apparatus comprises an audio capture device.

8. A coating of a consumer electronic device, wherein the consumer electronic device in an active state is configured to generate heat, the coating configured to:
have an emissivity of a first average value over an ultraviolet (UV) band of radiation and a near-infrared (NIR) band of radiation;
have an emissivity of a second average value over a visible band of radiation; and
have an emissivity of a third average value over a mid-to-far infrared band of radiation.

9. The coating of claim 8, wherein the first average value is less than the second average value, and the second average value is less than the third average value.

10. The coating of claim 8, wherein:
incident radiation in the UV band and the NIR band is substantially reflected by the coating;
incident radiation in the visible band is such that the coating appears as a target color; and
heat generated in the mid-to-far infrared band is substantially absorbed and re-radiated.

11. The coating of claim 8, wherein the coating comprises a multi-layered thin film or a multi-layered polymer film configured to selectively reflect specific wavelengths of incident light.

12. The coating of claim 8, wherein:
one or more thin films are applied to a first surface of the consumer electronic device; and
a paint coating is applied to a surface of the one or more thin films to form the coating as an aggregate coating.

13. The coating of claim 12, wherein:
the aggregate coating has an emissivity distribution that includes the UV band, the NIR band, the visible band, and the mid-to-far infrared band;
a first portion of the emissivity distribution in the UV and NIR bands is lower than a second portion of the emissivity distribution in the visible band;
the second portion of the emissivity distribution in the visible band is lower than a third portion of the emissivity distribution in the mid-to-far infrared band;
the aggregate coating presents as a target color; and
heat generated by the consumer electronic device in the mid-to-far infrared band is substantially absorbed and re-radiated.

14. The coating of claim 12, wherein the first surface is a surface of a substrate comprising at least one of: a plastic, a metal, and an ultra-high molecular weight polyethylene.

15. The coating of claim 12, wherein:
the one or more thin films are configured to decrease the emissivity in the UV band and the NIR band, and to increase the emissivity in the mid-to-far infrared band; and
the paint coating is configured to absorb and scatter light in the visible band while propagating light outside of the visible band.

16. The coating of claim 12, wherein a plurality of pigments in the paint coating selectively absorb and scatter light in the visible band.

17. A battery containment structure comprising:
a metal chassis configured to receive a battery, the metal chassis including five surfaces that are each coated with an electrical insulator; and
a lid configured to couple to the metal chassis, the lid configured to be coupled to the battery to form a battery assembly that when coupled to the metal chassis forms the battery containment structure.

18. The battery containment structure of claim 17, wherein the lid is coupled to the battery via a pressure sensitive adhesive to form the battery assembly.

19. The battery containment structure of claim 17, wherein the lid comprises a conductive pressure sensitive adhesive that forms a Faraday Cage with the metal chassis around the battery.

20. The battery containment structure of claim 17, wherein the lid comprises a pair of flanges positioned inside the metal chassis, the pair of flanges configured to align the battery assembly along a defined spatial dimension of the metal chassis.
